(19) United States
(12) Patent Application Publication
(10) Pub. No.: US 2017/0308535 A1
(43) Pub. Date: Oct. 26, 2017

(54) COMPUTATIONAL QUERY MODELING AND ACTION SELECTION

(71) Applicant: Microsoft Technology Licensing, LLC, Redmond, WA (US)

(72) Inventors: Alekh Agarwal, White Plains, NY (US); Miroslav Dudik, Brooklyn, NY (US); Akshay Krishnamurthy, New York, NY (US); John Langford, Scarsdale, NY (US); Adith Swaminathan, Ithaca, NY (US)

(21) Appl. No.: 15/136,688

(22) Filed: Apr. 22, 2016

(51) Int. Cl. G06F 17/30; G06N 7/00

(52) U.S. Cl. CPC G06F 17/3053; G06F 17/30554; G06N 7/005

(57) ABSTRACT

A computing device can determine a decomposition of data of actions of a first session based at least in part on a first computational model associating the actions of the first session with corresponding state values of the first session. The computing device can determine a second computational model based at least in part on the decomposition and an operation template. The computing device can receive a query via the communications interface, the query associated with the second session. The computing device can determine a state value of the second session based at least in part on the query. The computing device can operate the second computational model to determine at least one response associated with the query based at least in part on the state value of the second session. The computing device can provide an indication of the at least one response via the communications interface.

### BACKGROUND

Users increasingly turn to computing services, such as web search engines, for information or for answers to specific questions. Such services or other software applications are often configured to provide a customized user experience. For example, a website application may receive information related to the state of a user's interaction with a webpage, such as time of day, the age of the user, or the geographical locations of the user, among others. Based on this information, the website may provide a different user experience. For example, a news website may provide different new articles to be displayed to the user based on the user's age, the time of the visit, or the user's geographical location. The rule used to associate the state information with the selected content may be referred to as a policy. To identify effective policies, the operator of a website application can test a variety of policies. Traditional application testing tends to be a slow and expensive process.

### SUMMARY

This disclosure describes systems, methods, and computer-readable media for determining or evaluating computational models (CMs), and/or for using the computational models in, e.g., determining responses to queries made during a session, e.g., a communication session with an entity. In some examples, a computing device can determine a decomposition of data of actions of a first session based at least in part on a first computational model associating the actions of the first session with corresponding state values of the first session. The computing device can determine a second computational model based at least in part on the decomposition and an operation template. The computing device can then receive a query via the communications interface, the query associated with the second session, and determine a state value of the second session based at least in part on the query. The computing device can operate the second computational model to determine at least one response associated with the query based at least in part on the state value of the second session. The computing device can provide an indication of the at least one response via the communications interface. According to example techniques herein, a computing device can receive data of at least one response set associated with a session, the data for the at least one response set indicating a respective plurality of responses, a respective response order, and a respective result value. The computing device can determine, based at least in part on the data, a mapping providing as output a result value based on inputs of a response at a position in a response order. The computing device can then determine, based at least in part on the mapping, a computational model providing a scoring value for a candidate response set. According to example techniques herein, a computing device can determine aggregate result data based at least in part on data of an action set, an associated result value, and a first computational model that associates the action set with a corresponding state value. The action set can include a plurality of slots and respective actions. The computing device can determine aggregate occurrence data based at least in part on the data of the action set and determine second aggregate occurrence data based at least in part on a second computational model. The computing device can then determine a prediction value associated with the second computational model based at least in part on the aggregate result data, the aggregate occurrence data, and the second aggregate occurrence data.

This Summary is provided to introduce a selection of concepts in a simplified form that are further described below in the Detailed Description. This Summary is not intended to identify key and/or essential features of the claimed subject matter, nor is it intended to be used as an aid in determining the scope of the claimed subject matter. The term “techniques,” for instance, can refer to system(s), method(s), computer-readable instructions, module(s), algorithms, hardware logic, and/or operation(s) as permitted by the context described above and throughout the document.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar and/or identical items.

FIG. 1 is a block diagram depicting example scenarios for implementing determination and operation of computational model(s) as described herein.

FIG. 2 is a block diagram depicting an example computing device configured to participate in determination and operation of computational model(s) according to various examples described herein.

FIG. 3 is a block diagram of an example testing system.

FIG. 4 is a dataflow diagram depicting example module interactions during determination and/or operation of a computational model.

FIG. 5 is a flow diagram that illustrates example processes for determining and operating computational model(s) according to various examples described herein.

FIG. 6 is a flow diagram that illustrates example processes for operating computational model(s) and selecting actions according to various examples described herein.

FIG. 7 is a flow diagram that illustrates example processes for determining computational model(s) according to various examples described herein.

FIG. 8 is a flow diagram that illustrates example processes for operating computational model(s) and selecting actions according to various examples described herein.

FIG. 9 is a flow diagram that illustrates example processes for determining and/or operating computational model(s) according to various examples described herein.

FIG. 10 is a flow diagram that illustrates example processes for determining result information and/or values according to various examples described herein.

FIG. 11 is a flow diagram that illustrates example processes for determining computational model(s) according to various examples described herein.

FIG. 12 is a flow diagram that illustrates example processes for determining and/or operating computational model(s) according to various examples described herein.

### DETAILED DESCRIPTION

### Overview

Examples described herein provide techniques and constructs to improve the determination and operation of computational models (CMs), e.g., scoring and/or ranking models. Examples described herein provide techniques and constructs to permit a computing system to, e.g., more effectively respond to user queries, e.g., via an online service. For example, users searching online for a movie, such as “The Martian,” may be interested in tickets for tonight, show times for this weekend, cast and crew information, or the novel on which the movie is based. Examples herein employ computational models to more effectively provide relevant results to user queries. Examples herein can reduce the “time to success,” e.g., measured as the number of system interactions required by the user to achieve the user's goals, thus reducing the bandwidth required for communication between the system and the user. Examples herein can present results or take actions more relevant to the user than some prior schemes, reducing the elapsed time for the user to achieve the user's goals and thus reducing the power consumed by computing devices during the user's attempts to achieve the user's goals. Examples herein can reduce the amount of data required to determine a CM, reducing the data storage, electrical power, and/or processing power required to determine the CM.

Some examples use CMs to determine an action to be taken based on state information of a session of user interaction with the system. Such a CM is referred to herein as a “policy.” Example actions can include transmitting specific information to the user, e.g., text and/or hyperlink(s). In some examples, subsequent to, and/or in response to, taking the determined action, the system can receive and/or determine a result value (a “reward”) and a new state of the session. As used herein, a “session” can include one or more exchanges in which a query is received, an action set is determined, and action(s) of the action set are taken. A session can, but is not required to, include multiple interactions with a particular entity. Moreover, a particular sequence of interactions between an entity and a computing system can include one or more session(s). After one or more interactions, e.g., of a session, the system can update parameters of CMs to more accurately reflect the result value provided by each action in a particular state. In some examples, the result value is provided by a user or otherwise indicates how valuable the action was to the user. In an example of a web-search system, the state can include the query “the martian movie.” For a user searching for tonight's show times and tickets, actions such as automatically ordering tickets and/or connecting to a ticket-purchasing site are associated with high result values in this example. An action including presenting cast and crew information to the user is associated with a low result value in this example.

For clarity of explanation, examples of result values are discussed herein with reference to scalar, real- or integer-value result values, in which higher (or more positive) result values indicate higher user satisfaction or a more preferable action than do lower (or more negative) result values. However, these examples are not limiting. In other examples, unless expressly indicated, more preferable outcomes can be represented by more negative result values, with suitable changes to equations herein. For example, the result value can correspond to a cost. Result values can be positive or negative. Result values can be real- or integer-valued. Result values can be elements of a finite set of discrete numerical values, ordinal values, categorical values, or Boolean values (e.g., success vs. failure).

Accordingly, some examples herein permit determining actions of a computing system, e.g., results to be presented to a user, based on both short- and long-term contributions to assisting the user, rather than merely based on textual understanding of a single user query. In some examples, a policy can include a function that provides a score and/or other result value when given as input a state and action set. In some examples, a policy can include a function that provides a result value when given as input a state, a candidate action, and a position of the candidate action within an action set. In some examples, policies are selected and/or updated so that (state, action-set) and/or (state, action, position) tuples associated with, e.g., desired user outcomes correspond to high result values. For example, the result values (“reward values”) can represent the value of a selected action and/or set of actions to a participant in a session, e.g., a user of a computing service.

In some examples, data can be collected that corresponds to at least one session during which a computing system responded to a user and/or otherwise selected actions based on a first computational model. The data can further include information of result values associated with those actions. The collected data can be used to determine a second computational model in which actions are selected to produce higher result values. This can permit improving the operation of the computing system over time to more closely correspond to the demands of, e.g., users of the computing system.

For brevity, some examples herein are described with reference to the context of a web search service, e.g., BING, GOOGLE, &c. However, these examples are not limiting. Other contexts in which examples herein can be applied can include question-answering services; online help systems; technical-support systems; voice-based assistants, such as CORTANA, SIRI, GOOGLE NOW, & c.; dialog-based personal assistant software, e.g., interacting with a user via a text interface; other systems interacting with a user, e.g., in real time; automotive and/or healthcare diagnostic and/or recommendation systems; customized news-report systems; computerized search systems; spelling and/or grammar checkers that provide suggested corrections; transmission-optimization systems such as web full-page optimization systems that arrange elements and/or components of a web page for reduced page-load time; electronic user interfaces such as desktop and/or mobile graphical user interfaces (GUIs) that can adjust, e.g., size, color, and/or font to improve user efficiency; task-assignment systems, e.g., for computing clusters; software agents executing on computing devices such as desktops and/or smartphones; artificial intelligence for, e.g., non-player characters presented and automatically controlled in a gaming-style user interface; navigation and/or other informational kiosks, e.g., in museums; customer-service terminals such as airline check-in terminals at airports; and/or instant-messaging services.

Some prior schemes evaluate a candidate policy by selecting a response set using that policy and looking for a matching response set in logged data, e.g., of prior user interactions. However, the number of possible response sets is very large, so the probability of finding a match is very low. For a selection of the top i of j items, the number of possible response sets is on the order of jⁱ. In contrast, some examples herein evaluate a candidate policy by transforming logged data. This can permit evaluating a candidate policy using a number of logged data samples on the order of i×j. Reducing the number of logged data samples used for analysis can reduce the amount of memory required to store the logged data and/or the amount of processor time required to analyze the logged data samples. Reducing the number of logged data samples used for analysis can additionally reduce the amount of elapsed time required to log the data before analysis can proceed. Moreover, some examples herein evaluate a candidate policy in a way that can reduce the effects of bias in the determination of the CMs, and thereby improve accuracy with which a policy can select high-value results.

Other prior schemes evaluate a candidate policy by deploying both the candidate policy and a comparative policy, e.g., an existing policy, and collecting data during a particular time period of user interactions with both policies. This is referred to as “A/B testing.” However, A/B tests can often take one to two weeks, greatly reducing the number of policies that can be evaluated in a given period of time. Various examples herein permit evaluating candidate policies without deploying them, substantially reducing the time and expense of evaluation, and in some examples reducing network bandwidth consumption that would be required by an A/B test.

Still other prior schemes evaluate a candidate policy by presenting a small subset of response sets to human evaluators, who provide feedback on the quality of the responses in the response sets. Machine-learning techniques are then used to model the feedback and apply the modeled feedback to other response sets. However, these schemes can be expensive and time-consuming to carry out, and hence can only be done at a small scale. Moreover, such schemes may exhibit bias due to differences between individuals' evaluations of the relevance of particular responses. For example, one evaluator's evaluation of relevance of a particular response may not accurately reflect a user's evaluation of relevance of that response.

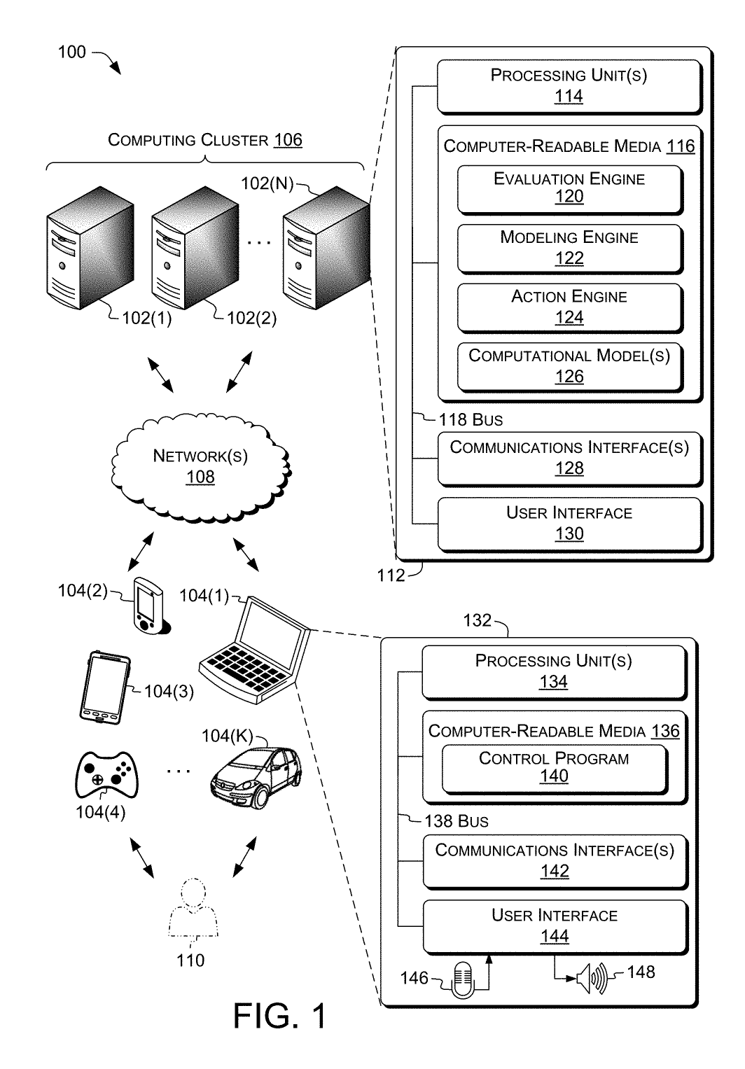

Various entities, configurations of electronic devices, and methods for determining and using computational models, e.g., for user-service applications, are described further with reference to FIGS. 1-12. While many examples described herein relate to servers and other non-consumer electronic devices, other types of electronic devices can be used, e.g., as discussed with reference to FIG. 1. References throughout this document to “users” can refer to human users and/or to other entities interacting with a computing system.

### Illustrative Environment

FIG. 1 shows an example scenario 100 in which examples of computational model systems, e.g., deep neural network (DNN) training systems and/or multi-model training and/or determining systems, can operate and/or in which computational-model determination and/or use methods such as those described herein can be performed. In the illustrated example, the various devices and/or components illustrated in scenario 100 include computing device(s) 102(1)-102(N) (individually and/or collectively referred to herein with reference 102), where N is any integer greater than and/or equal to 1, and computing devices 104(1)-104(K) (individually and/or collectively referred to herein with reference 104), where K is any integer greater than and/or equal to 1. In some examples, N=K; in other examples, N>K or N<K. Although illustrated as, e.g., desktop computers, laptop computers, tablet computers, and/or cellular phones, computing device(s) 102 and/or 104 can include a diverse variety of device categories, classes, and/or types and are not limited to a particular type of device.

In the illustrated example, computing device(s) 102(1)-102(N) can be computing nodes in a cluster computing system 106, e.g., a cloud service such as MICROSOFT AZURE, GOOGLE CLOUD PLATFORM, and/or another cluster computing system (“computing cluster” or “cluster”) having several discrete computing nodes (device(s) 102) that work together to accomplish a computing task assigned to the cluster as a whole. In the illustrated example, computing device(s) 104 can be clients of cluster 106 and can submit jobs to cluster 106 and/or receive job results from cluster 106. Computing devices 102(1)-102(N) in cluster 106 can, e.g., share resources, balance load, increase performance, and/or provide fail-over support and/or redundancy. Computing devices 104 can additionally or alternatively operate in a cluster and/or grouped configuration.

Some cluster-based systems can have all or a portion of the cluster deployed in the cloud. Cloud computing allows for computing resources to be provided as services rather than a deliverable product. For example, in a cloud-computing environment, resources such as computing power, software, information, and/or network connectivity are provided (for example, through a rental agreement) over a network, such as the Internet. As used herein, the term “computing” used with reference to computing clusters, nodes, and jobs refers generally to computation, data manipulation, and/or other programmatically-controlled operations. The term “resource” used with reference to clusters, nodes, and jobs refers generally to any commodity and/or service provided by the cluster for use by jobs. Resources can include processor cycles, disk space, random-access memory (RAM) space, network bandwidth (uplink, downlink, or both), prioritized network channels such as those used for communications with quality-of-service (QoS) guarantees, backup tape space and/or mounting/unmounting services, electrical power, etc.

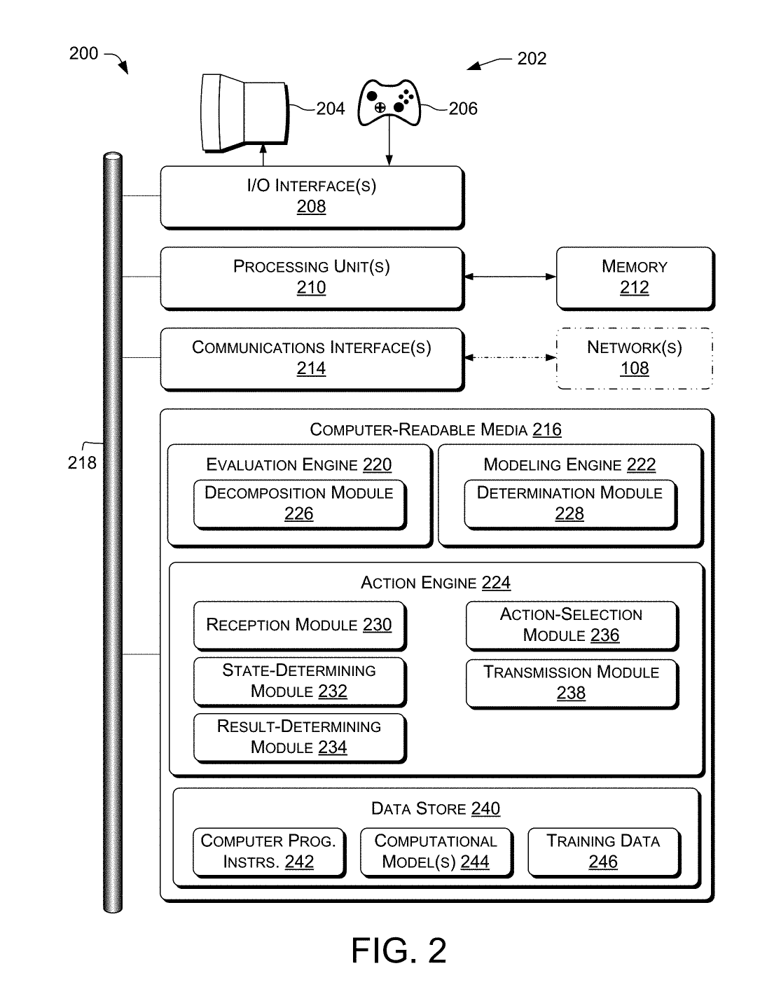

By way of example and not limitation, computing device(s) 102 and/or 104 can include, but are not limited to, server computers and/or blade servers such as web servers, map/reduce servers and/or other computation engines, and/or network-attached-storage units (e.g., 102(1)), laptop computers, thin clients, terminals, and/or other mobile computers (e.g., 104(1)), wearable computers such as smart watches and/or biometric and/or medical sensors, implanted computing devices such as biometric and/or medical sensors, computer navigation client computing devices, satellite-based navigation system devices including global positioning system (GPS) devices and/or other satellite-based navigation system devices, personal data assistants (PDAs), and/or other specialized portable electronic devices (e.g., 104(2)), tablet computers, tablet hybrid computers, smartphones, mobile phones, mobile phone-tablet hybrid devices, and/or other telecommunication devices (e.g., 104(3)), portable and/or console-based gaming devices and/or other entertainment devices such as network-enabled televisions, set-top boxes, media players, cameras, and/or personal video recorders (PVRs) (e.g., 104(4), represented graphically as a gamepad), automotive computers such as vehicle control systems, vehicle security systems, and/or electronic keys for vehicles (e.g., 104(K), represented graphically as an automobile), desktop computers, and/or integrated components for inclusion in computing devices, appliances, and/or other computing device(s) configured to participate in and/or carry out computational-model determination and/or operation as described herein, e.g., for control purposes. In some examples, as indicated, computing device(s), e.g., computing devices 102(1) and 104(1), can intercommunicate to participate in and/or carry out computational-model determination and/or operation as described herein. For example, computing device 104(K) can be or include a data source operated by a user and computing device 102(1) can be a computational-model determination and operation system, as described below with reference to, e.g., FIGS. 2-12.

Different devices and/or types of computing devices 102 and 104 can have different needs and/or ways of interacting with cluster 106. For example, computing devices 104 can interact with cluster 106 with discrete request/response communications, e.g., for queries and responses using an already-determined CM. Additionally and/or alternatively, computing devices 104 can be data sources and can interact with cluster 106 with discrete and/or ongoing transmissions of data to be used as input to a computational model. For example, a data source in an automobile, e.g., a computing device 104(K) associated with an interactive voice-response system in the automobile, can provide to cluster 106 data of location and environmental conditions around the car. This can provide improved accuracy of actions taken by vehicle control systems by increasing the amount of state data input to the computational model. Additionally and/or alternatively, computing devices 104 can be data sinks and can interact with cluster 106 with discrete and/or ongoing requests for data output from a computational model, e.g., updates to search results related to current events as news stories about those events are published.

In some examples, computing devices 102 and/or 104 can communicate with each other and/or with other computing devices via one or more network(s) 108. In some examples, computing devices 102 and 104 can communicate with external devices via network(s) 108. For example, network(s) 108 can include public networks such as the Internet, private networks such as an institutional and/or personal intranet, and/or combination(s) of private and public networks. Private networks can include isolated networks not connected with other networks, such as MODBUS, FIELDBUS, and/or Industrial Ethernet networks used internally to factories for machine automation. Private networks can also include networks connected to the Internet and/or other public network(s) via network address translation (NAT) devices, firewalls, network intrusion detection systems, and/or other devices that restrict and/or control the types of network packets permitted to flow between the private network and the public network(s).

Network(s) 108 can also include any type of wired and/or wireless network, including but not limited to local area networks (LANs), wide area networks (WANs), satellite networks, cable networks, Wi-Fi networks, WiMAX networks, mobile communications networks (e.g., 3G, 4G, and so forth) and/or any combination thereof. Network(s) 108 can utilize communications protocols, such as, for example, packet-based and/or datagram-based protocols such as Internet Protocol (IP), Transmission Control Protocol (TCP), User Datagram Protocol (UDP), other types of protocols, and/or combinations thereof. Moreover, network(s) 108 can also include a number of devices that facilitate network communications and/or form a hardware infrastructure for the networks, such as switches, routers, gateways, access points, firewalls, base stations, repeaters, backbone devices, and the like. Network(s) 108 can also include devices that facilitate communications between computing devices 102 and/or 104 using bus protocols of various topologies, e.g., crossbar switches, INFINIBAND switches, and/or FIBRE CHANNEL switches and/or hubs.

In some examples, network(s) 108 can further include devices that enable connection to a wireless network, such as a wireless access point (WAP). Examples support connectivity through WAPs that send and receive data over various electromagnetic frequencies (e.g., radio frequencies), including WAPs that support Institute of Electrical and Electronics Engineers (IEEE) 802.11 standards (e.g., 802.11g, 802.11n, and so forth), other standards, e.g., BLUETOOTH, cellular-telephony standards such as GSM, LTE, and/or WiMAX.

Different networks have different characteristics, e.g., bandwidth or latency, and for wireless networks, accessibility (open, announced but secured, and/or not announced), and/or coverage area. The type of network 108 used for any given connection between, e.g., a computing device 104 and cluster 106 can be selected based on these characteristics and on the type of interaction. An example data source can be a real-time data and/or video stream from a drone and/or other remotely-operated vehicle or from a webcam. Such a video stream can be carried via high-bandwidth, low-latency networks. By contrast, low-bandwidth networks can be used to carry textual queries from users, or data such as measurements from environmental sensors such as temperature sensors. Such sensors can provide infrequent updates, e.g., one value per minute of a gradually changing temperature.

In some examples, computing devices 102 and/or 104, e.g., laptops, smartphones, and/or other computing devices 102 and/or 104 described above, interact with an entity 110. The entity 110 can include systems, devices, parties such as users, and/or other features with which computing devices 102 and/or 104 can interact. For brevity, examples of entity 110 are discussed herein with reference to users of a computing system; however, these examples are not limiting. In some examples, computing device 104 is operated by entity 110, e.g., a user.

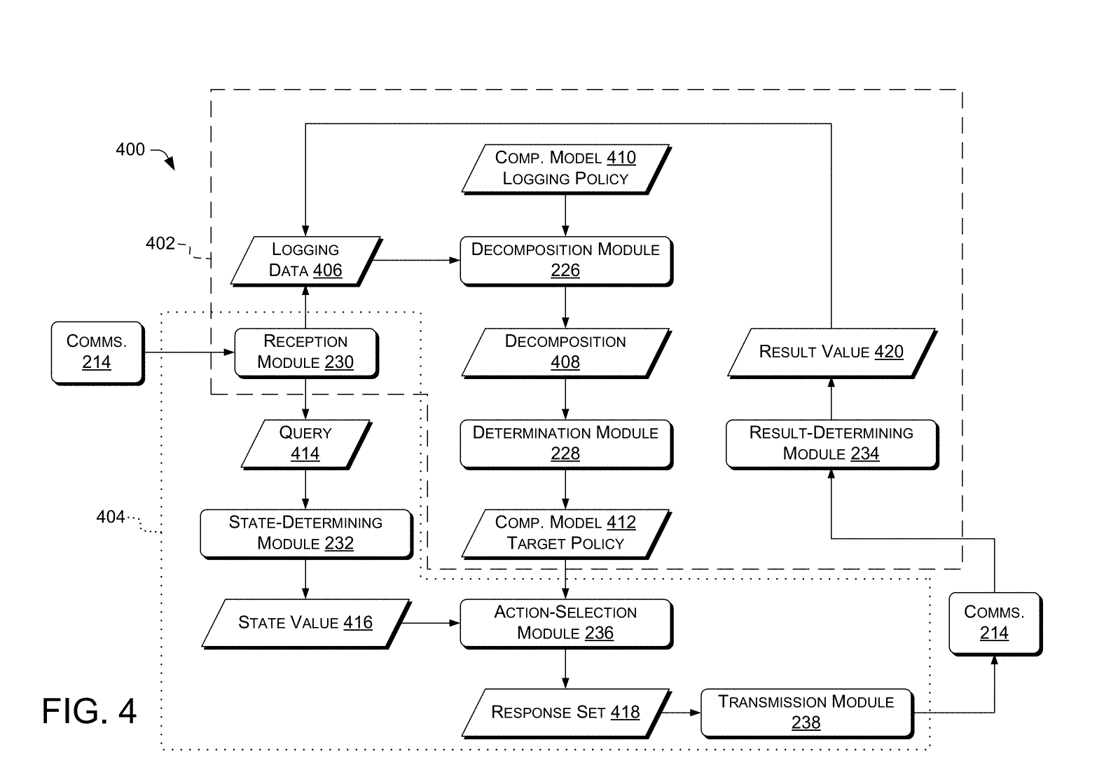

In some examples, computing devices 102 operate computational models to determine an action to be taken in response to a user query, and transmit an indication of the action via network 108 to computing device 104(3), e.g., a smartphone. Computing device 104(3) can take the action, e.g., by presenting a response to the user. Computing device 104(3) can then transmit information via network 108 to computing devices 102, e.g., information useful for determining result information. Computing devices 102 can then determine a result value, update one or more of the computational models, and/or determine a new action. Examples of this process are discussed in more detail below with reference to FIGS. 4-12.

Still referring to the example of FIG. 1, details of an example computing device 102(N) are illustrated at inset 112. The details of example computing device 102(3) can be representative of others of computing device(s) 102. However, each of the computing device(s) 102 can include additional or alternative hardware and/or software components. The illustrated computing device 102(N) can include one or more processing unit(s) 114 operably connected to one or more computer-readable media 116, e.g., memories, such as via a bus 118, which in some instances can include one or more of a system bus, a data bus, an address bus, a Peripheral Component Interconnect (PCI) Express (PCIe) bus, a PCI bus, a Mini-PCI bus, and any variety of local, peripheral, and/or independent buses, and/or any combination thereof. In some examples, plural processing units 114 can exchange data through an internal interface bus (e.g., PCIe), rather than and/or in addition to network 108. While the processing units 114 are described as residing on the computing device 102(N), in this example, the processing units 114 can also reside on different computing device(s) 102 and/or 104 in some examples. In some examples, at least two of the processing units 114 can reside on different computing device(s) 102 and/or 104. In such examples, multiple processing units 114 on the same computing device 102 and/or 104 can use a bus 118 of the computing device 102 and/or 104 to exchange data, while processing units 114 on different computing device(s) 102 and/or 104 can exchange data via network(s) 108.

Computer-readable media described herein, e.g., computer-readable media 116, includes computer storage media and/or communication media. Computer storage media includes tangible storage units such as volatile memory, nonvolatile memory, and/or other persistent and/or auxiliary computer storage media, removable and non-removable computer storage media implemented in any method and/or technology for storage of information such as computer-readable instructions, data structures, program modules, and/or other data. Computer storage media includes tangible and/or physical forms of media included in a device and/or hardware component that is part of a device and/or external to a device, including but not limited to RAM, static RAM (SRAM), dynamic RAM (DRAM), phase change memory (PRAM), read-only memory (ROM), erasable programmable read-only memory (EPROM), electrically erasable programmable read-only memory (EEPROM), flash memory, compact disc read-only memory (CD-ROM), digital versatile disks (DVDs), optical cards and/or other optical storage media, magnetic cassettes, magnetic tape, magnetic disk storage, magnetic cards and/or other magnetic storage devices and/or media, solid-state memory devices, storage arrays, network attached storage, storage area networks, hosted computer storage and/or memories, storage, devices, and/or storage media that can be used to store and maintain information for access by a computing device 102 and/or 104.

In contrast to computer storage media, communication media can embody computer-readable instructions, data structures, program modules, and/or other data in a modulated data signal, such as a carrier wave, and/or other transmission mechanism. As defined herein, computer storage media does not include communication media.

In some examples, computer-readable media 116 can store instructions executable by the processing unit(s) 114, e.g., incorporated in computing device 102. Computer-readable media 116 can store, for example, computer-executable instructions of an operating system (omitted for brevity), module(s) of a evaluation engine 120, module(s) of a modeling engine 122, module(s) of an action engine 124, and/or other modules, programs, and/or applications that are loadable and executable by processing unit(s) 114. For example, the computer-executable instructions stored on the computer-readable media 116 can upon execution configure a computer such as a computing device 102 and/or 104 to perform operations described herein with reference to the operating system, the evaluation engine 120, the modeling engine 122, and/or the action engine 124.

Computer-readable media 116 can also store one or more computational model(s) 126, individually and/or collectively referred to herein with reference 126. In some examples, algorithms for determination or operation of computational model(s) 126 as described herein can be performed on a computing device (e.g., computing device 102), such as a smart phone, a tablet, a desktop computer, a server, a server blade, a supercomputer, etc. The resulting models can be used on such computing devices and/or on computing devices (e.g., computing device 104) having one or more input devices, such as a physical keyboard, a soft keyboard, a touch screen, a touch pad, microphone(s), and/or camera(s). In some examples, functions described herein can be shared between one or more computing device(s) 102 and one or more computing device(s) 104.

In various examples, e.g., of computational models determined for responding to user queries and/or other use cases noted herein, the computational models may include one or more regression models, e.g., polynomial and/or logistic regression models; classifiers such as binary classifiers; decision trees, e.g., boosted decision trees, configured for, e.g., classification or regression; and/or artificial neurons, e.g., interconnected to form a multilayer perceptron or other neural network. A decision tree can include, e.g., parameters defining hierarchical splits of a feature space into a plurality of regions. A decision tree can further include associated classes, values, or regression parameters associated with the regions. A neural network (NN) can have none, at least one, or at least two hidden layers. NNs having multiple hidden layers are referred to as deep neural networks (DNNs).

In some examples, CMs 126 can include one or more recurrent computational models (RCMs). An RCM can include artificial neurons interconnected so that the output of a first unit can serve as a later input to the first unit and/or to another unit not in the layer immediately following the layer containing the first unit. Examples include Elman networks in which the outputs of hidden-layer artificial neurons are fed back to those neurons via memory cells, and Jordan networks, in which the outputs of output-layer artificial neurons are fed back via the memory cells. In some examples, an RCM can include one or more long short-term memory (LSTM) units. The computational model(s) 126 can include, e.g., one or more DNNs, RCMs such as recurrent neural networks (RNNs), deep RNNs (DRNNs), Q-learning networks (QNs) and/or deep Q-learning networks (DQNs), computational models such as those shown described herein with reference to Eqs. (1)-(9), and/or any combination thereof.

At least one of the computational model(s) 126 can include, e.g., activation weights, functions, and/or thresholds for artificial neurons and/or other computational units (e.g., LSTM units) of one or more neural networks; coefficients of learned ranking functions, e.g., polynomial functions; and/or parameters of decision trees and/or other classifiers, in some nonlimiting examples. These are referred to individually or collectively as “parameters” herein. The evaluation engine 120 can process logged data associated with a first computational model. The modeling engine 122 can determine values of parameters in a second computational model 126. The action engine 124 can use the determined second computational model 126 having the determined parameters to, e.g., determine a response to a user query, and/or to perform other data analysis and/or processing. The action engine 124 can communicate information, e.g., between entity 110 and computational models 126 designed for understanding user queries.

Modeling engine 122 can be configured to determine CMs 126, e.g., to apply NN-training techniques to determine neuron parameters of artificial neurons in the CMs 126. For example, modeling engine 122 can determine CMs 126 using a reinforcement-learning update rule. Modeling engine 122 can parallelize the training of the NNs and/or other determination algorithms for CMs 126 across multiple processing units, e.g., cores of a multi-core processor and/or multiple general-purpose graphics processing units (GPGPUs). For example, multiple layers of DNNs may be processed in parallel on the multiple processing units. Modeling engine 122 can train neural networks such as DNNs minibatch-based stochastic gradient descent (SGD). SGD can be parallelized along, e.g., model parameters, layers, and data (and combinations thereof). Other frameworks besides SGD can be used, e.g., minibatch non-stochastic gradient descent and/or other mathematical-optimization techniques. Modeling engine 122 can determine CMs 126 at least in part using an experience replay or “bag-of-transitions” reinforcement-learning update rule.

Computing device 102 can also include one or more communications interface(s) 128 connected via the bus 118 to processing units 114 to enable wired and/or wireless communications between computing device(s) 102 and other networked computing devices 102 and/or 104 involved in cluster computing, and/or other computing device(s), e.g., over network(s) 108. The processing units 114 can exchange data through respective communications interface(s) 128, which can transmit and receive data via bus 118 or network 108. In some examples, the communications interface 128 can include, but is not limited to, a transceiver for cellular (3G, 4G, and/or other), WI-FI, Ultra-wideband (UWB), BLUETOOTH, and/or satellite transmissions. The communications interface 128 can include a wired I/O interface, such as an Ethernet interface, a serial interface, a Universal Serial Bus (USB) interface, an INFINIBAND interface, and/or other wired interfaces. The communications interface 128 can additionally and/or alternatively include one or more user-interface devices, buses such as memory buses and/or local buses, memory interfaces, and/or hardwired interfaces such as 0-20 mA control lines. For simplicity, these and other components are omitted from the illustrated computing device 102(3).

In some examples, computing device 102 can include a user interface 130 configured to permit a user, e.g., entity 110 and/or a neural-network administrator, to operate the evaluation engine 120, the modeling engine 122, and/or the action engine 124. Some examples of user interface 130 are discussed below.

Details of an example computing device 104(1) are illustrated at inset 132. The details of example computing device 104(1) can be representative of others of computing device(s) 104. However, each of the computing device(s) 104 can include additional and/or alternative hardware and/or software components. Computing device 104(1) can include one or more processing unit(s) 134 operably connected to one or more computer-readable media 136, e.g., via a bus 138. Some examples of processing unit(s) 134 are discussed above with reference to processing unit(s) 114. Some examples of computer-readable media 136 are discussed above with reference to computer-readable media 116. For example, computer-readable media 136 can include one or more computer storage media. Some examples of bus 138 are discussed above with reference to bus 118.

Computer-readable media 136 can store, for example, computer-executable instructions of an operating system (omitted for brevity), an action engine (omitted for brevity), a control program 140 and/or module(s) thereof, and/or other modules, programs, and/or applications that are loadable and executable by processing unit(s) 136.

In some examples not shown, one or more of the processing unit(s) 114 or 134 in one of the computing device(s) 102 and/or 104 can be operably connected to computer-readable media 116 and/or 136 in a different one of the computing device(s) 102 and/or 104, e.g., via communications interface 128 and/or 142 and network 108. For example, program code to perform steps of flow diagrams herein, e.g., as described herein with reference to engines 120, 122, and/or 124, can be downloaded from a server, e.g., computing device 102(1), to a client, e.g., computing device 104(K), e.g., via the network 108, and executed by one or more processing unit(s) in computing device 104(K).

In some examples, the control program 140 can be configured to receive inputs, e.g., via a keyboard, transmit corresponding queries to a computing device 102, receive responses from computing device 102, and present the responses, e.g., via a display. In some examples, determination and operation of computational model(s) 126 are carried out on computing device(s) 102. In some examples, determination (e.g., updating) and/or operation of CM(s) 126 are carried out on a computing device 104. In some of these examples, the control program 140 can be configured to receive inputs, determine and/or operate computational model(s) 126 using instructions of evaluation engine 120, modeling engine 122, and/or action engine 124 based at least in part on those inputs to determine an action, and implement the determined action. In some examples, the control program 140 can include a web browser, smartphone app and/or desktop application, background service conducting and/or monitoring network communications, and/or instant-messaging client, and/or can include components of any of those configured to perform functions described herein. For clarity herein, without limitation, various examples are discussed with reference to a web browser. Other types of control programs 140 can be used with those examples except as expressly indicated.

In some examples, the computing device 104 can be configured to communicate with computing device(s) 102 to operate a neural network and/or other computational model 126. For example, the computing device 104 can transmit a request to computing device(s) 102 for an output of the computational model(s) 126, receive a response, and take action based on that response. For example, the computing device 104 can provide to entity 110 information included in the response, e.g., text and/or hyperlink(s). In some examples, at least one computing device 102 is configured to determine and/or update CM(s) 126. In some of these examples, computing device(s) 104 can be configured to transmit to the at least one computing device 102 state information that describes some aspect of the user interaction with the computing device(s) 104. In some examples, the at least one computing device 102 can be configured to transmit CM(s) 126 to computing device(s) 104, and the CM(s) 126 can be operated on computing device(s) 104 to determine action(s).

Computing device 104 can also include one or more communications interfaces 142 connected via the bus 138 to processing unit(s) 134 to enable wired and/or wireless communications between computing device(s) 104 and other networked computing devices 102 and/or 104 involved in cluster computing, and/or other computing device(s), over network(s) 108. Some examples are discussed above with reference to communications interface 128.

In some examples, computing device 104 can include a user interface 144. For example, computing device 104(3) can provide user interface 144 to control and/or otherwise interact with cluster 106 and/or computing devices 102 therein. For example, processing unit(s) 134 can receive inputs of user actions via user interface 144 and transmit corresponding data via communications interface 142 to computing device(s) 102.

User interface 130 and/or 144 can include or be operably connected to one or more input devices, integral and/or peripheral to computing device 102 and/or 104. The input devices can be user-operable, and/or can be configured for input from other computing device 102 and/or 104. Examples of input devices can include, e.g., a keyboard, keypad, a mouse, a trackball, a pen sensor and/or smart pen, a light pen and/or light gun, a game controller such as a joystick and/or game pad, a voice input device such as a microphone, voice-recognition device, and/or speech-recognition device, a touch input device such as a touchscreen, a gestural and/or motion input device such as a depth camera, a grip sensor, an accelerometer, another haptic input, a visual input device such as one or more cameras and/or image sensors, and the like. User queries can be received, e.g., from entity 110, via user interface 130 and/or user interface 144. In some examples, user interface 130 and/or user interface 144 can include a microphone 146 or other audio-input device, and computing device 104 can execute a speech-recognition engine (omitted for brevity) to determine, e.g., textual data of queries from input audio detected by microphone 146.

User interfaces 130 and/or 144 can include or be operably connected to one or more output devices configured for communication to a user and/or to another computing device 102 and/or 104. Output devices can be integral and/or peripheral to computing device 102 and/or 104. Examples of output devices can include a display, a printer, audio speakers, beepers, and/or other audio output devices, a vibration motor, linear vibrator, and/or other haptic output device, and the like. Actions, e.g., presenting information of or corresponding to an output of a CM 126 to entity 110, can be taken via user interface 130 and/or user interface 144. In some examples, user interface 130 and/or user interface 144 can include a speaker 148 or other audio-output device, and computing device 104 can execute a speech-synthesis engine (omitted for brevity) to determine, e.g., audio data of actions from text or other data of those actions, e.g., received via network 108. Although shown as part of computing device 104, microphone 146 and speaker 148 can be separate from computing device 104 and communicatively connectable therewith.

### Illustrative Components

FIG. 2 is an illustrative diagram that shows example components of a computing device 200, which can represent computing device(s) 102 and/or 104, and which can be and/or implement a computational-model determination and/or operation system, device, and/or apparatus. Computing device 200 can be, implement, include, and/or be included in system(s), device(s), and/or apparatus for determining and/or operating a neural network and/or other computational model, e.g., to rank candidate actions, according to various examples described herein. Example functions described below of computing device 200 can be, implement, include, and/or be included in method(s) for determining and/or operating CMs, e.g., to determine action sets and/or rank actions within a set, according to various examples described herein.

Computing device 200 can include and/or be connected to a user interface 202, which can represent user interface 130 and/or 144. User interface 202 can include a display 204. Display 204 can include an organic light-emitting-diode (OLED) display, a liquid-crystal display (LCD), a cathode-ray tube (CRT), and/or another type of visual display. Display 204 can be a component of a touchscreen, and/or can include a touchscreen. User interface 202 can include various types of output devices described above with reference to user interface 130 and/or 144. In some examples, computing device 200 can be communicatively connected with a user interface 144, FIG. 1, of another computing device.

User interface 202 can include a user-operable input device 206 (graphically represented as a gamepad). User-operable input device 206 can include various types of input devices described above with reference to user interface 130 and/or 144.

Computing device 200 can further include one or more input/output (I/O) interface(s) 208 to allow computing device 200 to communicate with input, output, and/or I/O devices (for clarity, some not depicted). Examples of such devices can include components of user interface 202 such as user-operable input devices and output devices described above with reference to user interface 130 and/or 144. Other examples of such devices can include power meters, accelerometers, and other devices for measuring properties of entity 110, computing device 200, and/or another computing device 102 and/or 104. Computing device 200 can communicate via I/O interface 208 with suitable devices and/or using suitable electronic/software interaction methods. Input data, e.g., of user inputs on user-operable input device 206, can be received via I/O interface 208 (e.g., one or more I/O interface(s)). Output data, e.g., of user interface screens, can be provided via I/O interface 208 to display 204, e.g., for viewing by a user.

The computing device 200 can include one or more processing unit(s) 210, which can represent processing unit(s) 114 and/or 134. In some examples, processing unit(s) 210 can include and/or be connected to a memory 212, e.g., a RAM and/or cache. Processing units 210 can be operably coupled to the I/O interface 208.

Processing unit(s) 210 can be and/or include one or more single-core processors, multi-core processors, CPUs, GPUs, GPGPUs, and/or hardware logic components configured, e.g., via specialized programming from modules and/or APIs, to perform functions described herein. For example, and without limitation, illustrative types of hardware logic components that can be used in and/or as processing units 210 include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), Digital Signal Processors (DSPs), and other types of customizable processors. For example, a processing unit 210 can represent a hybrid device, such as a device from ALTERA and/or XILINX that includes a CPU core embedded in an FPGA fabric. These and/or other hardware logic components can operate independently and/or, in some instances, can be driven by a CPU. In some examples, at least some of computing device(s) 102 and/or 104, FIG. 1, can include a plurality of processing units 210 of multiple types. For example, the processing units 210 in computing device 200 (e.g., computing device 102(3), FIG. 1) can be a combination of one or more GPGPUs and one or more FPGAs. Different processing units 210 can have different execution models, e.g., as is the case for graphics processing units (GPUs) and central processing unit (CPUs). In some examples at least one processing unit 210, e.g., a CPU, graphics processing unit (GPU), and/or hardware logic device, can be incorporated in computing device 200, while in some examples at least one processing unit 210, e.g., one or more of a CPU, GPU, and/or hardware logic device, can be external to computing device 200. In some examples of hardware configurations, e.g., ASICs, modules described herein can be embodied in or can represent logic blocks designed into the hardware. Such modules, in some examples, are considered to be stored within the hardware configuration. In some examples of firmware configurations, e.g., FPGAs, modules described herein can be embodied in or can represent logic blocks specified, e.g., by a configuration bitstream stored in a nonvolatile memory such as a Flash memory or read-only memory (ROM). Such modules, in some examples, are considered to be stored within the nonvolatile memory. The nonvolatile memory can be included within the FPGA or other device implementing the logic blocks, or can be separate therefrom (e.g., a configuration memory such as an ALTERA EPCS16).

The computing device 200 can also include a communications interface 214, which can represent communications interface 128 and/or 142. For example, communications interface 214 (e.g., one or more communications interface(s)) can include a transceiver device such as a network interface controller (NIC) to send and receive communications over a network 108 (shown in phantom), e.g., as discussed above. As such, the computing device 200 can have network capabilities. Communications interface 214 can include any number of network, bus, and/or memory interfaces, in any combination, whether packaged together and/or separately. In some examples, communications interface 214 can include a memory bus internal to a particular computing device 102 and/or 104, transmitting via communications interface 214 can include storing the transmitted data in memory 212 (and/or computer-readable media 216, discussed below), and receiving via communications interface 214 can include retrieving data from memory 212 and/or computer-readable media 216.

For example, the computing device 200 can exchange data with computing devices 102 and/or 104 (e.g., laptops, computers, and/or servers) via one or more network(s) 108, such as the Internet. In some examples, computing device 200 can receive data from one or more data source(s) (not shown) via one or more network(s) 108. Example data source(s) can include computing devices 102 and/or 104, data aggregators, and/or data feeds, e.g., accessible via application programming interfaces (APIs). The processing units 210 can retrieve data from the data source(s), e.g., via a Hypertext Transfer Protocol (HTTP) request such as a GET to a web Services and/or Representational State Transfer (REST) API endpoint.

Processing unit(s) 210 can be operably coupled to at least one computer-readable media (CRM) 216. In some examples, the processing unit(s) 210 can access module(s) on the computer-readable media 216 via a bus 218, which can represent bus 118 and/or 138, FIG. 1. I/O interface 208 and communications interface 214 can also communicate with processing unit(s) 210 via bus 218. In some examples, computer-readable media 216 of the computing device 200 can represent computer-readable media 116 and/or 136, FIG. 1. Computer-readable media 216 can store instructions executable by processing unit(s) 210, and/or instructions executable by external processing units such as by an external central processing unit (CPU) and/or external processor of any type discussed herein.

Computing device 200 can implement an evaluation engine 220, which can represent evaluation engine 120, FIG. 1. Computing device 200 can implement a modeling engine 222, which can represent modeling engine 122, FIG. 1. Computing device 200 can implement an action engine 224, which can represent action engine 124, FIG. 1.

Computer-readable media 216, e.g., computer storage media, can store a plurality of modules of the evaluation engine 220, the modeling engine 222, and/or the action engine 224; examples are discussed below. Processing unit(s) 210 can be configured to execute modules of the plurality of modules. For example, the computer-executable instructions stored on the computer-readable media 216 can upon execution configure a computer such as a computing device 200 to perform operations described herein with reference to the modules of the plurality of modules. The modules stored in the computer-readable media 216 can include instructions that, when executed by the one or more processing units 210, cause the one or more processing units 210 to perform operations described below.

Computer-readable media 216 can also include an operating system (omitted for brevity). In some examples, an operating system is not used (commonly referred to as a “bare metal” configuration). In some examples, the operating system can include components that enable and/or direct the computing device 200 to receive data via various inputs (e.g., user controls such as user-operable input device 206, network and/or communications interfaces, memory devices, and/or sensors), and process the data using the processing unit(s) 210 to generate output. The operating system can further include one or more components that present the output (e.g., display an image on electronic display 204, store data in memory 212 and/or CRM 216, and/or transmit data to another computing device). The operating system can enable a user to interact with the computing device 200 via user interface 202. Additionally, the operating system can include components that perform various functions generally associated with an operating system, e.g., storage management and internal-device management.

The modules of the evaluation engine 220 stored on computer-readable media 216 can include one or more modules (e.g., shell modules and/or API modules, and likewise throughout the document), which are illustrated as a decomposition module 226.

The modules of the modeling engine 222 stored on computer-readable media 216 can include one or more modules, which are illustrated as a determination module 228.

The modules of the action engine 224 stored on computer-readable media 216 can include one or more modules, which are illustrated as a reception module 230, a state-determining module 232, a result-determining module 234, an action-selection module 236, and a transmission module 238. In some examples, the reception module 230 (and/or the transmission module 238) can include, e.g., a network stack, a Berkeley sockets or Winsock client, and/or other computer program instructions to receive (transmit) data, e.g., via communications interface(s) 214.

In the evaluation engine 220, the modeling engine 222, and/or the action engine 224, the number of modules can vary higher and/or lower, and modules of various types can be used in various combinations. For example, functionality described associated with the illustrated modules can be combined to be performed by a fewer number of modules and/or APIs and/or can be split and performed by a larger number of modules and/or APIs. For example, the decomposition module 226 and the determination module 228 can be combined in a single module that performs at least some of the example functions described below of those modules, and/or likewise one or more of the reception module 230, the result-determining module 234, and the transmission module 238. In some examples, computer-readable media 216 can include a subset of the above-described modules.

In some examples using a linear-regression based scoring function, e.g., as discussed below, the decomposition module 226 of the evaluation engine 220 can determine a decomposition 408, FIG. 4, include functions useful for estimating the value of a response in a slot, e.g., per Eq. (4). The determination module 228 of the modeling engine 222 can determine a computational model 412, FIG. 4, by performing linear regression. The computational model 412 can thus include linear functions that map slot indices and numeric query-document feature values to predicted result values. For example, in Eq. (7), T(j, f) can compute a linear combination of j and f. The action-selection module 236 of the action engine 224 can determine the particular action set, e.g., response set, for a state (e.g., including a query), e.g., as discussed below with reference to Eq. (7).

In the illustrated example, computer-readable media 216 includes a data store 240. In some examples, data store 240 can include data storage, structured and/or unstructured, such as a database (e.g., a Structured Query Language, SQL, and/or NoSQL database) and/or data warehouse. In some examples, data store 240 can include a corpus and/or a relational database with one or more tables, arrays, indices, stored procedures, and so forth to enable data access. Data store 240 can store data for the operations of processes, applications, components, and/or modules stored in computer-readable media 216 and/or computer instructions in those modules executed by processing unit(s) 210. In some examples, the data store can store computer program instructions 242 (e.g., instructions corresponding to processes described herein and/or to other software executable by processing unit(s) 210), one or more computational models 244, which can represent computational models 126, FIG. 1, training data 246, e.g., datasets, to be used for determining and/or operation of the computational models 244, metadata, e.g., of datasets, database schema(s), and/or any combination thereof. In some examples, computational models 244 can include decision trees and/or artificial neurons, as discussed herein.

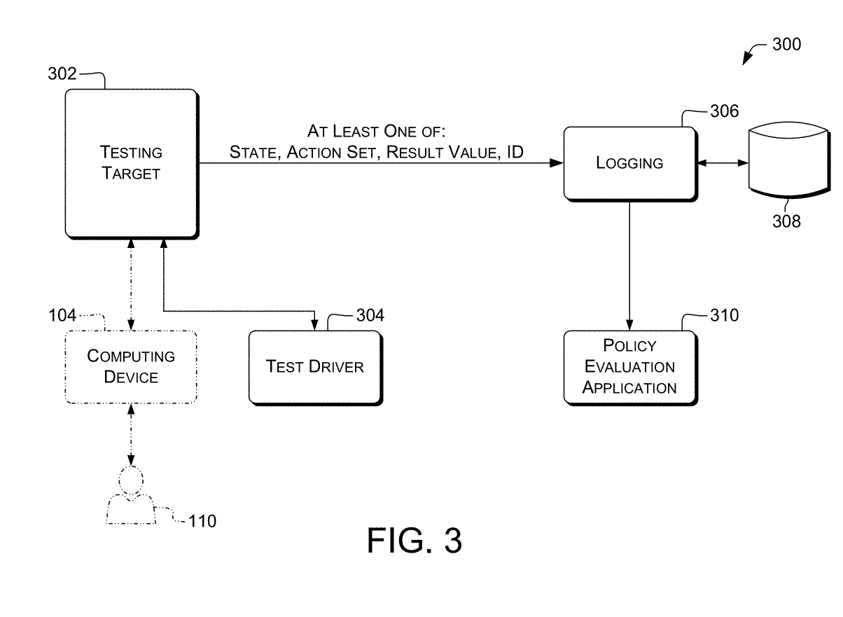

FIG. 3 is a block diagram of an example testing system 300 according to some examples described herein. System 300 can be implemented, e.g., using components described above with reference to FIGS. 1 and/or 2. System 300 is configured to test a “testing target” (or “target”) 302, e.g., a system, application, and/or device under test. The target 302 can be and/or include, e.g., substantially any type of application, such as a dynamic web page with configurable layout, a cloud computing service, and/or a search engine, ad exchange, a website with customizable content such as a news web site, an operating system interface, a computer game, an online multiplayer gaming environment, a web platform for a crowdsourcing market, and/or a recommendation system such as system that recommend movies, books and/or other items, and others. The target 302 may also be and/or include a component and/or subsystem of an application such as a user interface. In some examples, computing device 102 and/or 104 hosts and/or operates the target 302, and a user (and/or other entity 110, shown in phantom, and likewise throughout this document) interacts with the target 302 via computing device 104 (shown in phantom). The target 302 can be accessed by a number of computing devices 104, e.g., via network 108. For example, in some instances, computing device 102 can host a website and entity 110 can be a visitor to the website.

During testing of the target 302, the behavior of the target 302 can be determined based at least in part on one or more policies. Policies, e.g., as discussed above, can include rules for selecting an action to be performed by the target 302 based on state information that describes some aspect of the user interaction with the target 302. A policy can be, include, and/or be embodied in one or more computational model(s) 126 and/or 244. Examples of state information can include information about the age of the user, the geographical location of the user, the time at which a user interaction is taking place, the type of device that the user is using to access the target 302, and/or any other type of information that may pertain to the user interaction with the target 302. Actions that can be determined based at least in part on the policy can include things such as the presenting of particular search results in a particular order, and/or the displaying of advertisements, search results, news articles, and products available for purchase, among others. Policies can be specified by an administrator (e.g., owner and/or operator) of target 302 and may be designed and implemented to provide a better user experience and/or to improve some aspect of the target 302. For example, if the target 302 displays a list of news articles, the news articles may be selected according to a policy that selects particular news articles based on the age and/or interests of the user. In this way, the user may be more likely to be presented with choices that are appealing to the user.

The system 300 can be used to determine the effectiveness of various candidate policies that could be implemented by the target 302. The system 300 can include one or more application programming interfaces (APIs) that enable the target 302 to communicate with the system 300 during testing. During testing, actual policies, e.g., existing policies, can be used. Additionally or alternatively, test policies can be used. For example, actions can be selected for the purpose of gathering data that can later be analyzed to identify effective policies. The target 302 can be tested during normal user interactions, and/or during dedicated test phases. For example, entity 110 can interact with target 302 and data can be collected. Additionally or alternatively, test driver 304, e.g., a code module, can operate target 302 in the absence of an entity 110, e.g., during a dedicated test phase.

Testing can involve data gathering operations that are performed by the system 300, e.g., according to specifications provided by the administrator of the target 302. Various user interactions with the target 302 (and/or target 302 operations controlled by test driver 304, and likewise throughout this document) can trigger data gathering operations. Examples of user interactions include initiating an initial access of the target 302, initiating a search, clicking on a link, selecting an option, entering text in a textbox, purchasing a product and/or service, visiting an advertiser, pressing a button, touching a touchscreen, and/or speaking within range of a microphone 146, among others. The gathered data can be used by system 300 to evaluate policies that may be employed by the target 302, and/or to determine new policies. In some examples, data collected during normal user interactions can be used to evaluate candidate policies without requiring deployment and extended AB testing of the candidate policies.

When a user, e.g., entity 110, interacts with the target 302, the target 302 can obtain state information regarding the interaction. The type of state information to be gathered can be specified, e.g., by the administrator of the target 302. Some types of state information may be received from a computing device 104, while other types of state information may be determined by the target 302. For example, the user may be prompted by the target 302 to provide login information, which may be used by the target 302 to obtain previously stored information about the user. Some state information may be received from cookies stored on the user system 108. The target 302 may be configured to enable the user to decide whether data can be collected (opt-in or opt-out) about the user and/or the user's interaction with the target 302. The target 302 may be configured such that the user is asked to provide consent before data about the user and/or the user's interaction with the target 302 are collected, and/or that specific data are not collected if consent is withheld.

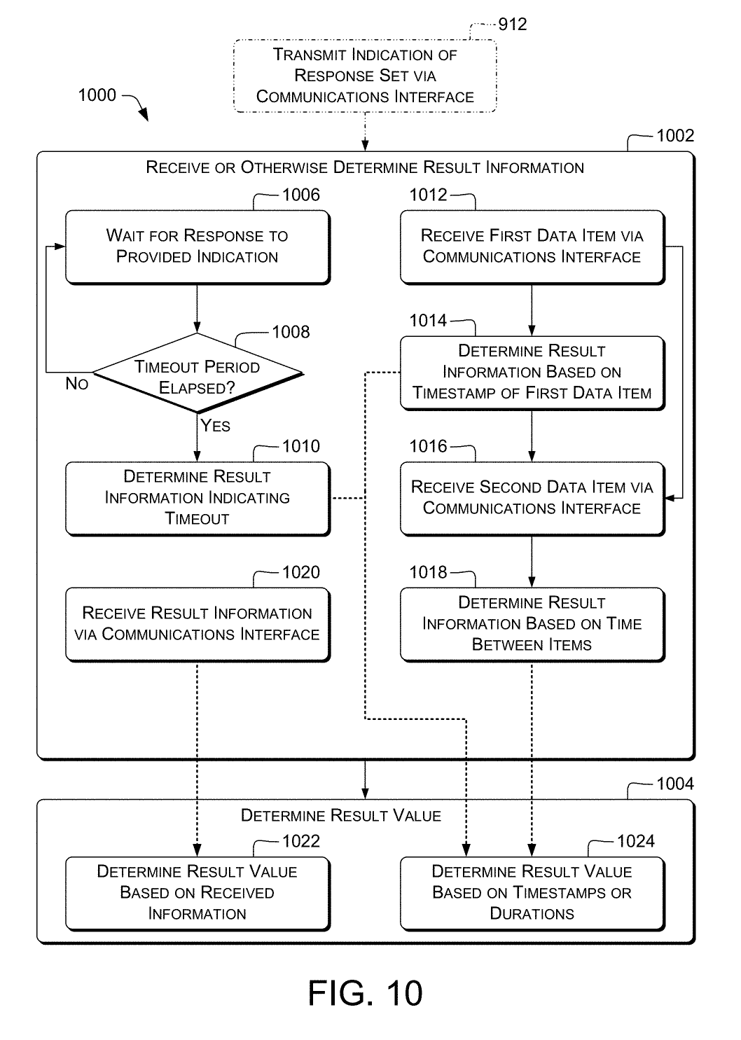

In some examples, such as for user interactions with the target 302 requiring a response (e.g., submission of a query to a search engine), the target 302 can make decision(s) regarding various possible actions of the target 302. In some examples, the target 302 can determine a set of actions that are available and can then select one or more of the actions. Additionally or alternatively, throughout this discussion at least some of the decision(s) can be made by the test driver 304 and/or another component. After the chosen action and/or set of actions has been performed, e.g., by presenting responses to the user, the user's further interaction with the target 302 can be used to determine result value(s) that can be used to evaluate the effectiveness of the chosen action. For example, if the decision was a decision regarding which product to display, the result value may indicate whether the user clicked on the link corresponding with the product, added the product to a shopping cart, completed a purchase of the product, and/or some combination thereof. In some examples of web search, the result value can include, and/or can be determined based at least in part on, click-through data, dwell-time data, and/or other types of data described below with reference to FIG. 10.

The system 300, e.g., using logging component 306, can log at least some of the data corresponding to the user interactions, e.g., at least some of the state information, the chosen action, and the result value. The logged data 308 can then be evaluated by the system 300 to identify effective policies. To evaluate the logged data 308, the system 300 can include a policy evaluation application 310. In some examples, the policy evaluation application 310 can include one or more modules of at least one of the evaluation engine 220, the modeling engine 222, and/or the action engine 224. The policy evaluation application 310 can extract information from the logged data 308. The policy evaluation application 310 can determine statistical information based on the logged data 308, in some examples. The logged data 308 and/or statistical information can be used to identify a policy and/or set of policies that produce desired results, and/or to determine how effectively a policy provides desired results. The effectiveness of a policy can determined based on a result function such as Eqs. (5) and/or (6), in some examples. For example, if the policy relates to determining which news articles to display, the result function may correspond to the percentage of people who linked to one of the news articles. In this way, the system 300 can be used to evaluate various policies to determine which policies are more effective. The system 300 can be configured for use with substantially any target 302, e.g., based on specifications provided by the administrator of the target 302.

In some examples, the target 302 can use one of several algorithms to select the action, including fixed algorithms and adaptive decision algorithms, examples of which are explained further below. The selected action is then implemented by the target 302. After implementing the action, the target 302 obtains result data that corresponds to the behavior of the user in response to the action and reports the result data, e.g., alone and/or in association with identifier(s) such as a session identifier and/or a unique a transaction identifier. The logging component 306 can receive the state information, selected action, and result data, and store the data to a data storage device 206.

The target 302 can implement various decision algorithms for selecting the action to be performed. For example, the target 302 can be programmed with a set of possible algorithms that can be selected by the target 302. The decision algorithms can include fixed and adaptive decision algorithms. A fixed decision algorithm is an algorithm wherein decisions are made without regard to result data received in connection with previous decisions. In some examples, the decision algorithm includes randomly selecting an action from the action set. The decision algorithm can also include eliminating one or more actions from the action set to generate a reduced action set and randomly selecting an action from the reduced action set. For example, actions may be eliminated from the action set if the action is unlikely to provide useful data.

An adaptive decision algorithm is an algorithm wherein actions are selected based on information extracted through analysis of previous decisions and the result data corresponding to those decisions. For example, if the result data corresponding to a specific action indicates that the action is unlikely to be useful to user, the decision algorithm can eliminate the action from the action set. The decision algorithm can then randomly select one of the remaining actions in the reduced action set. The determination of whether an action is likely to be useful can also take into account the state information. For example, a user query may require the target 302 to select one or more movie choices to present to a user. Based on previous decisions and the corresponding result data, it may be determined that people of a certain demographic are unlikely to purchase movies of a particular genre. In that case, the target 302 may eliminate movies of that genre from the action set when the state information indicates that the user is within the relevant demographic.

To implement adaptive decision algorithms, the target 302 can store state information. The target 302 can then can analyze previous chosen actions to determine which actions may be likely to produce more useful data by comparing previously chosen actions and the state information associated with the previously chosen actions. For example, the target 302 can eliminate one or more actions from the action set and/or rank the actions according to their respective likelihood of being useful, e.g., to the user. In some adaptive decision algorithms, the target 302 may select one or more low-probability actions and one or more actions that are in accordance with a policy that best fits the received state information. For this and other adaptive algorithms, the target 302 can interact with the system 300 to determine the effectiveness of policies as new test data is collected and logged.

In both the fixed and adaptive decision algorithms, decisions can be randomized to provide an appropriate level of exploration over possible actions. In some examples, the randomization may be weighted in favor of certain actions. For example, if the result data associated with a particular action indicates a high probability of being useful to a user, the action may be weighted more heavily by the target 302 in future decisions.

During testing of the target 302, there is a chance that the experimental decisions provided by the target 302 will be much less effective than would otherwise be the case if a known policy were being implemented. Accordingly, testing of the target 302 could result in reduced application performance. The performance of the target 302 can be described by a one or more statistical values that are computed based on the received result data. The system 300 can use the performance data to ensure that the performance of target 302 is not excessively degraded during the gathering of test data.

To ensure an acceptable level of performance, the target 302 can provide an exploration budget and a default policy to the system 300. The exploration budget and default policy can be provided to the system 300 when the target 302 initializes with the system 300. The exploration budget may be a threshold value that corresponds with an acceptable level of performance reduction as measured by the result data and acts as a safeguard against performance degradation due to exploration. The default policy can include a policy and/or policies known to provide an acceptable level of performance, which may be specified by a default performance parameter.

As the target 302 executes, the system 300 and/or the target 302 can compute one or more performance statistics, which are statistics that relate to the cumulative effectiveness of the selected actions as measured by the result data reported by the target 302. The system 300 and/or the target 302 can compare the computed performance statistics to the default performance value, and if the performance difference between the computed performance statistics and the default performance value exceeds the exploration budget, then the system 300 and/or the target 302 can begin return decisions using the default policy rather than the decision algorithm. The system 300 and/or the target 302 can continue updating the computed performance statistics during execution based on the result data received for actions selected using the default policy. Once the difference between the computed performance statistics and the default performance value is within the exploration budget, the system 300 and/or the target 302 can resume selecting actions based on the selection algorithm rather than the default policy.

In some cases, the target 302 may not have continuous access to the system 300 during testing. To ensure that testing can take place even when the target 302 does not have access to the system 300, the system 300 and the target 302 can be configured to support a disconnected mode. In disconnected mode, decisions are made locally on the target 302 according to a current policy, e.g., received from the system 300. The current policy can act as a fixed policy during the time that the target 302 is disconnected from the system 300. The current policy may be communicated from the system 300 to the target 302 during a time when the target 302 is connected. After each decision, the target 302 can temporarily log state information, action-set information, and result information to a data storage device of and/or associated with the target 302. When connectivity is restored, the logged data 308 can be communicated to the system 300. If the target 302 is using an adaptive decision algorithm, the decision algorithm can be updated and pushed back to the target 302 each time the target 302 reconnects with the system 300.

The policy evaluation application 310 permits evaluating candidate polic(ies) with respect to the logged test data. This can permit identifying effective policies to be used in the target 302. In some examples, the policy evaluation application 310 determines statistical data related to the effectiveness of the candidate policy. A candidate policy refers to a policy that could be implemented in the target 302 and is being submitted to the policy evaluation application 310 to determine the results that would likely be obtained if the policy was actually implemented. The candidate policy may be and/or include a mapping of state information to specified actions and/or sets of actions, as noted above. For example, if the policy is related to the selection of news articles, one mapping may specify that articles related to the user's home country should be selected. Any suitable combination of state information can be used in the candidate policy. To evaluate a candidate policy, the policy evaluation application 310 can use a result function. The result function, as noted above, can compute a result statistic based on, e.g., the result data that has been logged during application testing. For example, the result function may compute the percentage of instances in which an article hyperlink presented to the user was selected by the user for reading (“click-throughs”).

The policy evaluation application 310 can access any and/or all of the logged test data, e.g., relevant to the candidate policy. Information relevant to the candidate policy can include any log entry that contains data that matches the parameters of the candidate policy. The policy evaluation application 310 can compute the result statistic against the relevant data according to the result function. A variety of candidate policies can be evaluated to determine which policy and/or set of policies may be more effective based on the returned result statistic. In some examples, each candidate policy in a group of candidate policies can be evaluated to determine the relative effectiveness of the candidate policies based on the result statistics computed for each candidate policy. In some examples, candidate policies can be selected based on effectiveness, for example, the most effective policy, the top two most effective policies, and so on.

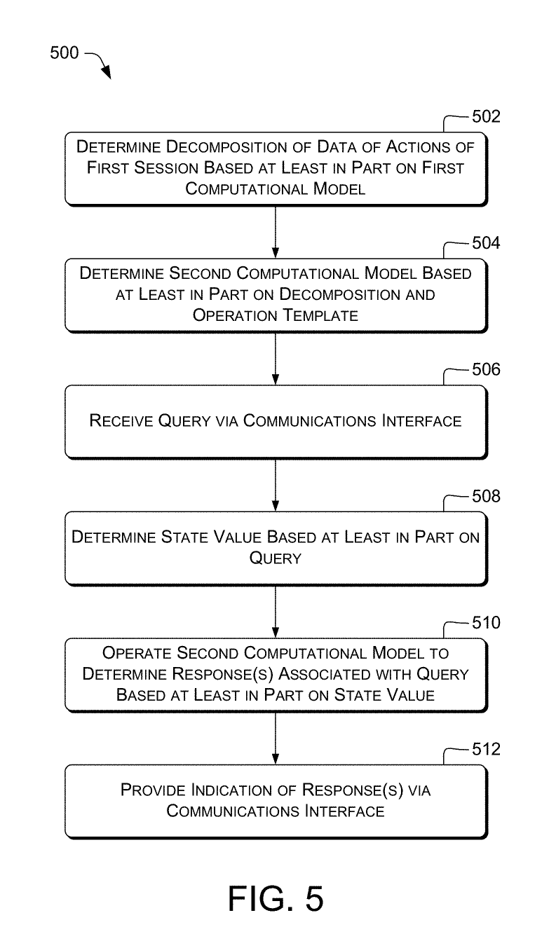

FIG. 4 is a dataflow diagram 400 illustrating example interactions between the modules illustrated in FIG. 2. For clarity, communications interface 214 is depicted multiple places in this figure. Such depiction does not constrain the number of communications interface(s) 214 that may be used. Further details of operations herein are described below with reference to FIGS. 5-12. Modules described herein with reference to FIGS. 2-4 can be configured to perform functions described below, e.g., with reference to FIGS. 5-12. Group 402 includes items primarily related to determination of computational models 126. Group 404 includes items primarily related to operation of computational models 126.

For notational clarity, indexing in vectors and/or arrays can be indicated by subscripts and/or by square brackets. A single dimension can be indexed with multiple values in row-major or column-major order. For example, for a 100-element vector v arranged as ten groups of ten elements, v [3 5] can be the 35th (3*10+5th) element of v, in row-major order, or the 53rd (5*10+3rd) element of v, in column-major order. In another example, for a 10×10 matrix m, m[3, 5] can be the element of m in the third row and the fifth column.

For clarity of explanation, data and operations shown in FIG. 4 are discussed herein with reference to a nonlimiting example of search. A computerized search system (or “search engine”) conducts at least one session. During a session, entity 110 submits at least one query Q to the search engine, and the search engine provides one or more search results. In this example, the actions taken by the search engine can include presenting specific documents as search results. To respond to a query Q, the search engine determines a state x, which can include query Q. State x can additionally include other state data described above, e.g., with reference to FIG. 3. The search engine chooses a response set S (a “slate”) having l “slots,” at least one of which may include a response such as a search result. For example, the search engine can return 10 results per page, so l can be equal to 10. The response set S can therefore include up to l responses sⱼ=S[j], jε[1,l]. Some examples permit null responses so that the response set can have exactly l responses, some of which may be null.

Each response sⱼ can be selected from a set of “allowed responses” Aⱼ(x) for slot j in response to state x. In this search-engine example, Aⱼ(x) can be the search function that returns a set of candidate query results for slot j. Particular ones of the candidate query results can be selected so that the selected query results in slots 1 . . . j are arranged in order of result value (“reward”). For example, the candidate query result associated with the highest reward value can be selected for the first slot. In some examples, a single A function is used, e.g., ∀j: Aⱼ(x)=A(x). For clarity, and without limitation, in the search-engine example, each slot can include one of at most m possible responses, e.g., ∀j:|Aⱼ(x)|≦m. In other examples, individual slots can have different maximum numbers of possible responses. In some examples in which, e.g., each slot has a unique query result, functions Aⱼ(x), j>1, can return candidate query results not already listed in slots 1 . . . j−1.

A response set S is an example of an action set in which each action includes presenting and/or transmitting a particular response. The discussion of response sets herein is also applicable to action sets including other types of actions. Various examples of action sets are discussed herein.

In some examples, the reception module 230 can be configured to receive logging data 406, e.g., via the communications interface 214. The logging data 406 can represent training data 246, FIG. 2. The logging data 406 can include, e.g., data of actions of (e.g., in, during, and/or associated with) a communication session. The logging data 406 can additionally or alternatively include data of an action set. The action set can include a plurality of slots, respective actions, and respective result values. Actions can include, e.g., presenting and/or transmitting responses. The logging data 406 can additionally or alternatively include data of a plurality of response sets of a session. The logging data 406 for at least one response set of the plurality of response sets can indicate a respective plurality of responses, a respective response order, and a respective result value.

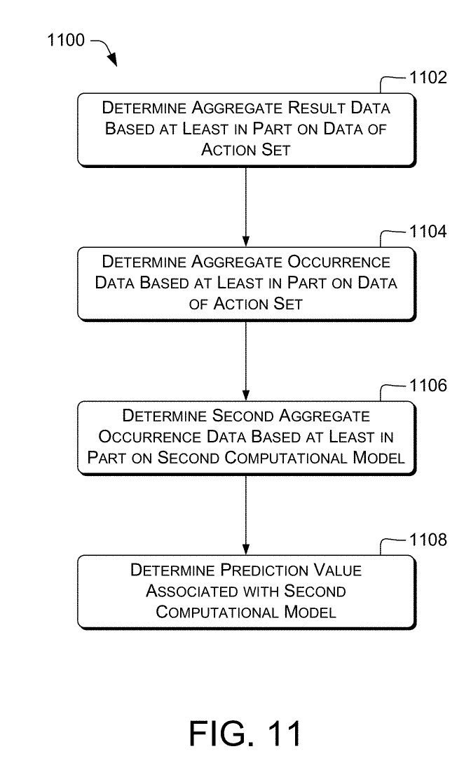

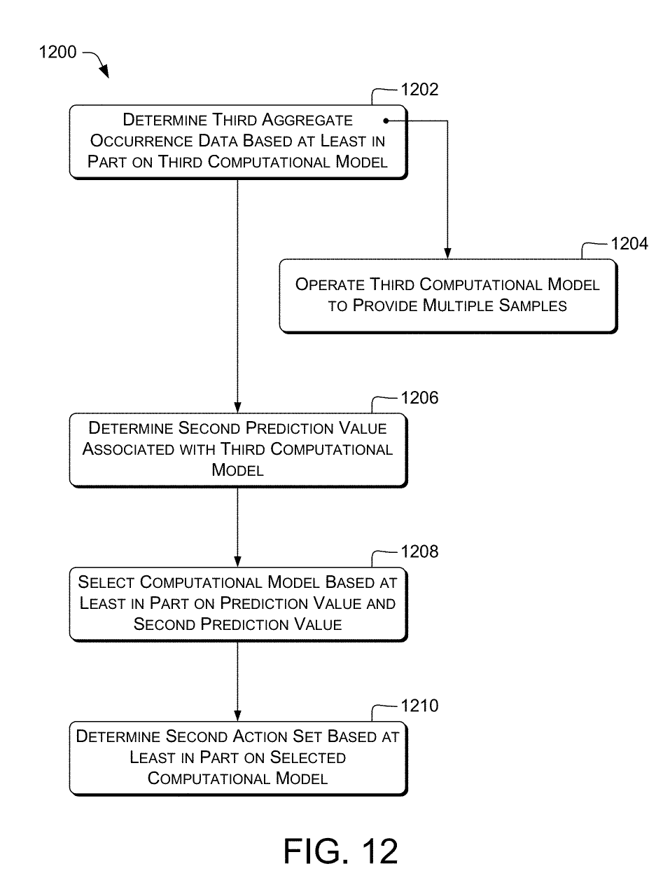

In some examples, the decomposition module 226 can be configured to determine a decomposition 408 of the logging data 406 based at least in part on a first computational model (CM) 410. The first CM 410 can associate the actions of a first session with corresponding state values of the first session. For example, the first CM 410 can be operated to determine a probability of a particular set of actions, and/or a particular set of actions itself, in a response to a particular state value. The state values can include one or more fields of the same or different data types. The first computational model 410 is referred to for brevity herein as a “logging policy.” For example, the logging data 406 can represent data collected during normal operation of target 302 during which operation actions were selected based on the logging policy (CM 410). The decomposition 408 can include, e.g., aggregate result data, aggregate occurrence data, and/or a combination thereof, as discussed below with reference to FIGS. 11 and 12.

In the search example, the logging data 406, denoted L, can include N records. Each record Lᵢ, iε[1, N], can include state data xᵢ including query Qᵢ, the response set Sᵢ determined for query Qᵢ, and a result value rᵢ indicating the reward associated with response set Sᵢ in response to query Qᵢ. The response set Sᵢ can be associated with a logging policy μ, e.g., the first CM 410. The logging policy μ can be stored or otherwise represented in, or associated with, the logging data 406. For example, the logging policy μ (first CM 410) can be stored in the data store 240, and a unique identifier of the logging policy μ can be stored in or otherwise associated with individual record(s) or groups of record(s) of the logging data 406. The logging policy μ is discussed in more detail below with reference to Eq. (3). The decomposition module 226 can determine an indicator vector Indᵢ for each response set i, as in Eq. (1). In some examples, Indᵢε [symbol] ^{lm}.

$${Ind}_{i} [ j a ] = \{ \begin{matrix}1 , & {S}_{i} [ j ] = a \\ 0 , & otherwise\end{matrix} \qquad ( 1 )$$

The decomposition module 226 can determine aggregate result data based at least in part on the logging data 406 and the logging policy (CM 410), as in Eq. (2).

\hat{θ}ᵢ=rᵢIndᵢ (2)

In some examples, the result value rᵢ can be associated with a response set Sᵢ as a whole, rather than with a particular response Sᵢ[j] in the response set Sᵢ. The aggregate result data can associate the result value rᵢ of a particular response set Sᵢ with the slots and responses in that response set Sᵢ. The aggregate result data can additionally or alternatively include moments of the logging policy (CM 410). The moments can represent the mathematical expectation of the result values for various combinations of slots and actions under the logging policy.

The decomposition module 226 can determine aggregate occurrence data based at least in part on the logging policy (CM 410). CM 410, e.g., a stochastic model, can be represented by a function μ(c|x) that returns a probability that, in a response set associated with state x, condition c will hold. For example, μ(sⱼ=a|x) can represent the probability that slot j will have action a in a response set associated with state x. Individual entries of a matrix Γ of aggregate occurrence data can be determined as in Eq. (3).

$${Γ}_{μ , {x}_{i}} ( j , a , k , {a}^{′} ) = \{ \begin{matrix}μ ( {s}_{j} = a \vert x ) & j = k a = {a}^{′} \\ μ ( {s}_{j} = a , {s}_{k} = {a}^{′} \vert x ) , & j \neq k \\ 0 , & otherwise\end{matrix} \qquad ( 3 )$$

for slots j and k and actions a and a′. In some examples, aggregate occurrence data Γ_{μ,x}_{ᵢ} includes a matrix, e.g., [symbol] ^{lm×lm}, with entries Γ_{μ,x}_{ᵢ}[j a, k a′]=Γ_{μ,x}_{ᵢ}(j, a, k, a′). In some examples, the first case in Eq. (3) can represent the contribution of a particular action to the result value of an action set. In some examples, the second case in Eq. (3) can represent the effect on the result value due to other actions in the action set. In some examples, other ways of aggregate occurrence data can be used than Eq. (3). For example, aggregate occurrence data can be determined by determining adjustments that relate the result value for an action set to the result value for a slot-action pair. The adjustments can represent, e.g., the likelihood that two or more particular actions will occur in the same slot or action set. The adjustments can model the fact that each slot-action pair provides only a portion of the result value, so only that portion of the result value should be assigned to each slot-action pair. In a nonlimiting example, if two particular actions co-occur in every action set in the logging data 406, each of those particular actions should be assigned no more than 0.5 times each result value in the logging data 406. The adjustments can model, e.g., at least one of the co-occurrence or the factor of 0.5, or the combination of the co-occurrence and the factor of 0.5. In some examples, the result value for an action set is considered to be a sum of individual result values for the slot-action pairs in that action set. An example using a sum is discussed below with reference to Eq. (5).

The decomposition module 226 can determine the decomposition from the aggregate result data and the aggregate occurrence data, as in Eq. (4).

\hat{φ}ₓ_{ᵢ}=Γ_{μ,x}_{ᵢ}^{†}\hat{θ}ᵢ=Γ_{μ,x}_{ᵢ}^{†}(rᵢIndᵢ) (4)

where m^{†} represents the pseudoinverse of a matrix m, e.g., the Moore-Penrose pseudoinverse. In some examples, the decomposition can be an lm-element vector. For example, \hat{φ}ₓ_{ᵢ}[j a] can represent a predicted result value for an action a in a slot j of a response set determined in state xᵢ. In some examples, the decomposition can be a function of arguments j and a rather than a vector.

In some examples, such as web search, the result value rᵢ is given per response set rather than per response/position pair. As a result, the result value (e.g., user feedback) does not provide per-response and/or per-response-plus-slot feedback, in some examples. For example, time-to-click and time the user spends reading a response set are commonly-used metrics that are not directly tied to individual responses, but are functions of the entire response set. Eqs. (1)-(4) permit decomposing set-level feedback to determine surrogate relevance values related to the responses and positions (and/or response-position pairs). In some examples, \hat{φ}ₓ_{ᵢ}[j a] values represent the contribution of individual responses (and/or other actions) in respective slots to the observed result value rᵢ. This can permit rearranging responses according to a new policy and estimating the results, even when only set-level logging data 406 are available.

Eq. (4) shows an example of solving a system of linear equations relating the aggregate occurrence data θ to the aggregate result data φ. Such a system can be of the form, e.g., θ=Γφ. The “θ” values in such a system can be determined using the logging data 406, e.g., as in Eq. (2). The coefficients (“Γ” values) of such a system can be determined based at least in part on the logging policy, e.g., μ in Eq. (3) (e.g., first CM 410). In some examples, the decomposition can be determined by solving the system, e.g., by reduction, cancellation of terms, Gaussian elimination, and/or other appropriate mathematical techniques. In some examples, the system can be solved using techniques robust to noise, e.g., introduced by the use of sampling.

The determination module 228 can determine a second computational model 412. The second CM 412 is referred to herein for brevity as a “target policy.” As noted above with respect to first CM 410, second CM 412 can associate state values with actions and/or action sets. The target policy can be determined to have, e.g., a desired probability of producing higher result values than the logging policy (first CM 410) if deployed. In some examples, the determination module 228 can determine the target policy (second CM 412) by determining candidate response sets for a given state and using the decomposition to predict the result values for those response sets. The predicted result for a candidate response set S={s₁, . . . , sₗ} in a state x can be determined as in Eq. (5).

$$\hat{r} ( x , S ) = {\sum }_{j = 1}^{𝓁} {\hat{φ}}_{x} [ j {s}_{j} ] \qquad ( 5 )$$

In some examples, the \hat{φ}ₓ[j sⱼ] values can, but are not required to, represent, e.g., per-action, per-slot metrics. In some nonlimiting examples, the \hat{φ}ₓ[j sⱼ] values can represent terms in a Normalized Discounted Cumulative Gain (NDCG) summation, e.g., for click NDCG and/or relevance NDCG; time-to-success values; search-relevance commitment (SSRX) values; utility rates; user clicks or other interactions with a response in a response set 418; dwell time on a response in a response set 418; and/or other merit score(s) of a document and a slot. In some examples, \hat{φ}ₓ[j sⱼ]=\hat{φ}(j, x, sⱼ). In some examples, Eq. (5) can permit modeling contributions to a response set 418 made by individual responses in the set without requiring the \hat{φ}(j, x, sⱼ) values to follow a particular functional form.

In some examples, the per-action, per-slot metrics in an example NDCG formulation can be as in Eq. (5b).

$$\hat{φ} ( j , x , {s}_{j} ) = \frac{{2}^{rel ( x , {s}_{j} )} - 1}{{log}_{2} ( j + 1 ) {DCG}^{*} ( x )} \qquad ( 5 b )$$

where rel(x, a)≧0 is a relevance of action a to state x and DCG*(x) is as in Eq. (5c).

$${DCG}^{*} ( x ) = {max}_{s ∈ S} DCG ( x , s ) \qquad ( 5 c )$$

where S is a set of possible action sets. DCG(x, s), in some examples, is as in Eq. (5d).

$$DCG ( x , s ) = {\sum }_{j = 1}^{𝓁} \frac{{2}^{rel ( x , {s}_{j} )} - 1}{{log}_{2} ( j + 1 )} \qquad ( 5 d )$$

for an action set s in a state x.

The determination module 228 can use “learning to rank” (L2R) algorithms, e.g., regression and/or neural-network training, to determine a candidate policy (e.g., a CM). For example, regression techniques can be used to determine a scoring function based on the results of the decomposition. In some examples, the determination module 228 can then operate the candidate policy, e.g., to determine response sets S for states x stored in the logging data 406 and/or other states (e.g., states containing at least some randomly-generated data). Using Eq. (5) and the decomposition, the determination module 228 can determine predicted result values \hat{r} for those response sets S. The determination module 228 can then adjust the candidate policy, e.g., using backpropagation (e.g., for NNs), hill-climbing algorithms (e.g., for function optimization), and/or other regression and/or L2R techniques, and repeat testing using the adjusted policy.

In some examples, Eq. (5) is not used, and a regressor and/or other L2R technique is applied directly to the decomposition \hat{φ} from Eq. (4). For example, a decomposition \hat{φ}ₓ_{ᵢ} having lm elements can be considered lm separate regression examples, each corresponding to xᵢ and to the respective j and a in the predicted result value \hat{φ}ₓ_{ᵢ}[j a], as noted above. Query-response features F(xᵢ, a) (e.g., query-document features) can be determined for individual responses a in state xᵢ. For example, the function F can return a feature vector of state xᵢ, response a (e.g., a particular document identified by response a), and/or a combination thereof. Regression can then be performed to determine parameters of an operation template, e.g., a function and/or a decision tree, that maps the query-document features and the position in a slate to predicted result values from Eq. (4). Example notation is shown in Eq. (6).

T(j,F(xᵢ,a))→\hat{φ}ₓ_{ᵢ}[ja] (6)

In Eq. (6), T(•) represents the operation template, which takes as inputs a position j within a response set and the query-document features F(xᵢ, a) of the response a being considered for inclusion at position j in a response set responsive to state xᵢ. Parameter(s) of T(•) can be adjusted, e.g., by regression, so that the output of T(•) together with the parameters approximates \hat{φ}ₓ_{ᵢ}[j a]. In some examples, using \hat{φ}xᵢ[j a] values as the targets of the regression can reduce bias introduced in some prior schemes by regressing based on per-response-set rewards.

Upon convergence of adjustments, regression, and/or other determination of the candidate policy as described in the preceding paragraphs, and/or when the candidate policy meets selected performance criteria (e.g., percentage improvement in average result values compared to the logging policy), the determination module 228 can determine the target policy (second CM 412) to be substantially the same as the adjusted candidate policy. For example, the target policy can include the operation template noted in the previous paragraph, populated with parameters determined by the regression. The target policy can thus map, e.g., query-document features to predicted result values associated with those query-document features. The target policy can then be used, e.g., in responding to queries.

In some examples, a candidate policy can be determined and/or adjusted using the Theano and/or scikit-learn packages for PYTHON, and/or another symbolic/numerical equation solver, e.g., implemented in C++, C#, MATLAB, Octave, and/or MATHEMATICA. For example, at least one of decomposition module 226 and/or determination module 228, FIG. 2, can be implemented using, and/or can include, invocation(s) of the scikit-learn “fit( )” function to fit, e.g., gradient-boosted regression trees, linear functions, or other functional forms to regression data. Examples are discussed above with reference to Eq. (6). In some examples, Theano can be used to perform NN training, e.g., using the “grad( )” and “function( )” routines.

In some examples, a learning-step function can be given as input a randomly-selected minibatch of the training data at each call in order to determine and/or adjust the model according to stochastic gradient descent (SGD) techniques. In some examples, computational models can be determine or adjusted using SGD with momentum. Grid search can be used to select the learning rate for, e.g., NN training and/or other CM determination and/or adjustment. Alternatively, several candidate policies can be determined using various learning rates and the candidate policy best satisfying acceptance criteria, e.g., of accuracy and/or precision, can be selected.

In some examples, the reception module 230 can be configured to receive a query 414, e.g., via the communications interface 214. The query can include, e.g., at least one of free-form user text, such as a query string; a User-Agent and/or other identifier of a computing device 104 via which the query 414 is provided; and/or other state information described above. In some examples, the logging data 406 and the query 414 are associated with the same session. In other examples, discussed herein for brevity and without limitation, the logging data 406 are associated with a first session and the query 414 is associated with a second session, e.g., a different session.

In some examples, the state-determining module 232 can be configured to determine a state value 416, denoted x_{q}, of the second session (the session associated with the query, in this example) based at least in part on the query. For example, as discussed above, the state information x_{q} can include at least part of the query, e.g., in the form of text and/or other representations (e.g., bag-of-words and/or feature-vector). The state information x_{q} can additionally or alternatively include data related to the session, e.g., duration and/or earlier queries. Including earlier queries in the state can permit, e.g., determine that a query for “martian” following a query for “movies” likely refers to the Ridley Scott film rather than the Andy Weir novel.

In some examples, the action-selection module 236 and/or another module can be configured to determine a plurality of possible responses to the query 414, e.g., possible answers to a user's question and/or resources, such as hyperlinks, that may be relevant to the query 414. The possible responses can be selected, e.g., using a full-text search algorithm, keyword filtering, and/or other search technique(s), in some examples. For example, APACHE LUCENE and/or another full-text search engine can be provided the query 414 and the state value 416, and can return an indication of which members of a document set are possible responses. In some examples, possible responses can be selected, filtered, and/or ranked based at least in part on transactional information, discount information, and/or other information stored in a knowledge base. Example actions include, but are not limited to, the following. Action “output(x)” as used herein is an action that presents information x to entity 110. Action “linkto(x)” transmits information indicating that entity 110 should retrieve a resource addressed by hyperlink x. For example, linkto(x) can transmit an HTTP 307 Temporary Redirect status code including hyperlink x as the value of a “Location” header. Action “results( )” transmits a list of search results to entity 110.

In some examples, the action-selection module 236 can be configured to operate the target policy (second CM 412) to determine a plurality of responses associated with the query 414 based at least in part on the state value 416 of the second session. The plurality of responses is illustrated as response set 418. For example, the action-selection module 236 can determine query-action features for each of the possible responses, e.g., in various slots of a response set. The action-selection module 236 can then operate the target policy to determine predicted result values for the possible responses in the various slots. The action-selection module 236 can then select the l response-slot combinations that have the highest predicted result values and provide the plurality of responses arranged in descending order of predicted result value. For example, using the notation of Eq. (6), the action-selection module 236 can select C candidate tuples=(j_{c}, a_{c}), cε[1, C], each tuple K_{c} representing placing possible response a_{c} in slot j_{c} of a response set (1≦j_{c}≦,l). The action-selection module 236 can then determine a predicted result value \hat{φ}_{c} for each tuple K_{c} as in Eq. (7).

\hat{φ}_{c}=T(j_{c},F(x_{q},a_{c})) (7)

The action-selection module 236 can then select the l tuples K_{c} having the highest \hat{φ}_{c} values as the plurality of responses. In some examples, action results( ) can transmit those l tuples ordered with the highest \hat{φ}_{c} value first. As shown, in some nonlimiting examples, the action-selection module 236 can use the second CM 412 (the target policy), and can operate without access to the logging data 406. For example, logging data 406 can be processed by computing device 102 but not provided to a computing device 102 or 104 operating second CM 412, although this is not limiting.

In some examples, the transmission module 238 can be configured to provide an indication of the plurality of responses via the communications interface 214. For example, the response set 418 can include and/or be transmitted embodied in and/or as a web page, JAVASCRIPT Object Notation (JSON) record, Structured Query Language (SQL) result set, and/or other result form.

In some examples, result-determining module 234 can determine a result value 420 associated with the query 414, and with the response set 418 associated with the query 414. In the illustrated example, result-determining module 234 can determine the result value 420 based at least in part on data received via the communications interface 214. Examples are discussed below, e.g., with reference to FIG. 10. As shown, in some examples, result value 420 can be added to the logging data 406 and/or otherwise processed to further improve the target policy (second CM 412).

In some examples, operations of group 402 are performed online. For example, the operations can be performed for each individual action set and associated state and result value. In some examples, evaluation of a candidate policy and/or policies can be performed incrementally as logging data 406 become available. In some examples, operations of group 402 are performed offline. For example, action sets, states, and result values can be recorded in minibatches in logging data 406. Determination module 228 can then determine the second CM 412 offline using one or more minibatches, e.g., a plurality of minibatches. Determination module 228 can determine the second CM 412 in a stochastic manner, e.g., by selecting minibatches at random from logging data 406. In some examples, using stochastic techniques can provide improved speed of convergence and/or improved numerical stability of the CM-determination process.

In some examples, operations of group 402 are performed partially offline. For example, during operations of group 404, a selected number (e.g., 100) of action sets and associated states and result values can be stored in logging data 406. Once the selected number of sets has been stored, determination module 228 can determine the second CM 412 based at least in part on the stored logging data 406.

In some examples of a minibatch and/or other offline and/or partially offline CM-determination configuration, the decomposition 408 can be determined in batch before the second CM 412 is determined. In some examples, the decomposition 408 and second CM 412 can be determined in parallel. In some examples, operating in batch can improve processing speed and/or stability of the CM-determination process.

In some examples, as noted above, a particular sequence of interactions between an entity and a computing system can include one or more session(s), e.g., the first session and the second session. In some examples, therefore, operations of group 402 can be performed, e.g., in parallel with a sequence of interactions between an entity and a computing system, or between interactions of such a sequence. For example, after a first session including a predetermined number or elapsed time of entity interactions with a computing system, a target policy (second CM 412) can be determined. The target policy can then be used for subsequent interactions of a second session between that entity and the computing system. The first session and the second session can abut in time; for example, the interaction immediately following the last interaction of the first session can be the first interaction of the second session.

### Illustrative Processes

FIG. 5 is a flow diagram that illustrates an example process 500 for determining and operating computational model(s) 126. For example, as discussed herein with reference to FIG. 4, steps of process 500 can be used to, e.g., determine a target policy and use the target policy to respond to queries. The search-engine example above is used herein and throughout the discussion of FIGS. 5-12 for clarity of explanation. In the search-engine example, responses are examples of actions. However, actions are not limited to the output( ), linkto( ), and/or results( ) actions discussed above.

Example functions shown in FIG. 5 and other flow diagrams and example processes herein can be implemented on and/or otherwise embodied in one or more computing device(s) 102 and/or 104, e.g., a computing device 200, e.g., using software running on such device(s). For the sake of illustration, the example process 500 is described below with reference to processing unit 210 and other components of computing device 200, FIG. 2, that can carry out and/or participate in the steps of the exemplary method. However, other processing unit(s) such as processing unit 114 and/or other components of computing device(s) 102 and/or 104 can carry out step(s) of described example processes such as process 500. Similarly, exemplary method(s) shown in FIGS. 5-12 are also not limited to being carried out by any specifically-identified components.

The order in which the operations are described in each example flow diagram and/or process is not intended to be construed as a limitation, and any number of the described operations can be combined in any order and/or in parallel to implement each process, except when otherwise specified, or in specific nonlimiting examples in which data produced in an earlier operation is used in a later operation. In each flow diagram, fewer than all of the depicted operations can be performed, except as expressly noted. Moreover, the operations in each of FIGS. 5-12 can be implemented in hardware, software, and/or a combination thereof. In the context of software, the operations represent computer-executable instructions that, when executed by one or more processors, cause one or more processors to perform the recited operations. In the context(s) of firmware and/or hardware, the operations represent logic functions implemented in circuitry, e.g., datapath-control and finite-state-machine sequencing functions. Therefore, descriptions of operations below also describe such software, firmware, and/or hardware structures to carry out the described functions. For example, the modules of FIGS. 2 and/or 4 can perform functions described with reference to the flowcharts.

In some examples, at block 502, a decomposition can be determined of data of actions of a first session based at least in part on a first computational model. The first computational model, e.g., first CM 410, can be a logging policy. The first computational model can associate the actions of the first session with corresponding state values of the first session, e.g., by virtue of having been used to determine the actions of the first session based on the state values of the first session. The state values xᵢ can include multiple values of multiple types, as noted above. The decomposition can include, e.g., \hat{φ} values determined, e.g., as in Eq. (4). Examples are discussed above, e.g., with reference to the decomposition module 226, Eqs. (1)-(4), and/or FIG. 4.

In some examples, the decomposition can include a plurality of relevance functions. In some examples, the relevance functions can include, e.g., mappings from a state, slot, and action to the predicted result value \hat{φ}ₓ_{ᵢ}[j a], Eq. (4). At least one relevance function of the plurality of relevance functions, and/or each relevance function, can be associated with a modifier value and can be configured to determine a predicted result value for a particular action in association with a particular state value and the modifier value. For example, the actions Sᵢ[j] of the first session, e.g., in state xᵢ, can be associated with respective positions, e.g., slot indices j, in at least one action set, e.g., response set Sᵢ. A modifier value, in these and other examples, can include a position, e.g., slot index j.

In the examples of Eqs. (4) and (5), the modifier value is the slot index j. A particular response a_{c} can be associated with a different predicted result value depending on the slot index. For example, an action that is very relevant to the query but is placed in the last slot index (j=l) may have a lower predicted result value than a less-relevant action placed in the first slot index (j=1), since web-search users tend to pay more attention to results in earlier slot indices than to results in later slot indices. Therefore, in some examples, the predicted result value \hat{φ}ₓ_{ᵢ}[j a] is a function both of slot j and of action a.

The modifier value is not limited to a slot index in an action set. In other examples, the modifier value can represent the placement of a search result and/or other response on a web page, e.g., main content, header, left sidebar, right sidebar, and/or footer. In still other examples, the actions can represent computing jobs, and the modifier values can represent times, e.g., at which respective ones of the computing jobs will be run by a computing cluster 106.

In some examples, therefore, an action set can include ranked item(s) of information (e.g., responses) to provide to entity 110. The slots can be associated with the rankings (slot order). Such examples can include, e.g., web search, question-answering services, and/or other interactive systems noted above. In some examples, an action set can include ranked diagnostics and/or recommendations, e.g., for automotive and/or other diagnostic and/or recommendation systems noted above and/or for spelling and/or grammar checkers. In some examples, an action set can include assignment(s) of specific elements to specific positions and/or configurations of a system, e.g., web full-page optimization systems and/or computing-cluster job schedulers. The slots can be associated with the positions and/or elements of the configurations. Other examples include web portal configurators that can, e.g., determine which components to place in which content areas (header, sidebar, . . . ) of a web page. In some examples, an action set can include configuration selections for specific elements of a system, e.g., size, color, and/or font choices of a GUI. The slots can be associated with the elements of the system. In some examples, an action set can include apportionments of a fixed set of resources to a set of slots. The slots can be associated with possible recipients of the resources. Examples include systems performing selection with and/or without replacement to, e.g., assign content resources to transmission resources, e.g., in a broadcast network.

In some examples, at block 504, a second computational model can be determined based at least in part on the decomposition and an operation template. The second CM, e.g., second CM 412, can be a target policy. The operation template can be a function T(•), e.g., as in Eq. (6). Examples are discussed above, e.g., with reference to the determination module 228 and/or FIG. 4.

In some examples, at block 506, a query 414 can be received via the communications interface 214. The query 414 can be associated, e.g., with the second session and/or another session. Examples are discussed above, e.g., with reference to the reception module 230 and/or FIG. 4.

In some examples, at block 508, a state value x_{q} of the second session can be determined based at least in part on the query 414. Examples are discussed above, e.g., with reference to the state-determining module 232 and/or FIG. 4.

In some examples, at block 510, the second computational model 412 can be operated to determine at least one response, e.g., a plurality of responses, associated with the query 414 based at least in part on the state value x_{q} of the second session. Examples are discussed above, e.g., with reference to the action-selection module 236 and/or FIG. 4. In some examples, the at least one response can include plurality of responses, at least one of which is a null response. In an example of web search, the search engine can return up to ten results per page (l=10). However, if only five responses are pertinent to the query (e.g., have predicted result values exceeding a selected threshold), the plurality of responses can include only the five pertinent responses, and/or can include the five pertinent responses plus five null responses. In some examples, a first response of the at least one response can match a second response of the at least one response (duplicate actions within a particular action set can be permitted). For example, in a system selecting colors for rooms of a house and/or elements of a graphical design, the actions can indicate particular colors. In some examples, two or more rooms and/or elements can have substantially the same color (e.g., the actions can be duplicated for those rooms and/or elements). In other examples, duplicate actions within a particular action set can be prohibited.

In some examples, the at least one response comprises a plurality of responses associated with respective positions in a response set. Block 510 can include determining the respective positions based at least in part on scoring values provided by the second computational model 412 for respective responses of the plurality of responses and the state value x_{q} of the second session. Examples are discussed above, e.g., with reference to the action-selection module 236 and/or FIG. 4.

In some examples, at block 512, an indication of the at least one response, e.g., the plurality of responses, can be provided via the communications interface 214. Examples are discussed above, e.g., with reference to FIG. 4. For example, individual responses of the at least one response can include at least text and/or hyperlink(s) (e.g., output( ) and/or linkto( ) actions) and the communications interface 214 can include a network interface. In some examples, block 512 can be followed by block 506. In this way, multiple queries can be processed using the computational model.

In some examples, block 512 can be followed by block 502. This can permit updating the computational model during a session and/or between sessions to increase the accuracy of the predicted result values from the computational model.

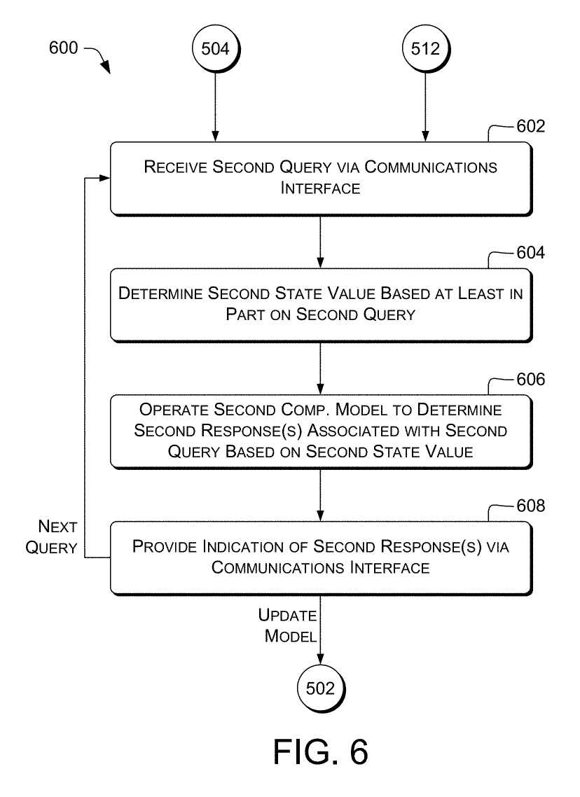

FIG. 6 is a flow diagram that illustrates an example process 600 for operating computational model(s). Block 602 can follow at least one of blocks 504-512, e.g., block 504 and/or block 512.

In some examples, at block 602, a second query can be received via the communications interface 214. The second query can be associated with the second session, and/or with a third session and/or other session. Examples are discussed above, e.g., with reference to block 506.

In some examples, at block 604, a second state value of the second session can be determined based at least in part on the second query. Examples are discussed above, e.g., with reference to block 508.

In some examples, at block 606, the second computational model can be operated to determine at least one second response associated with the second query based at least in part on the second state value of the second session. Examples are discussed above, e.g., with reference to block 510. The at least one second response can include, e.g., a second slate of l actions. The at least one response from block 510 and the at least one second response can have, e.g., zero, one, or at least one actions in common. Common actions can have the same modifier values (e.g., slot indices) in the at least one response and the at least one second response, and/or can have different modifier values, in any combination.

In some examples, at block 608, an indication of the at least one second response can be provided via the communications interface 214. Examples are discussed above, e.g., with reference to block 512. In some examples, block 608 can be followed by block 602 (“Next Query”). In this way, multiple queries can be processed. In some examples, block 608 can be followed by block 502 (“Update Model”). In this way, the computational model can be updated, e.g., as discussed above with reference to block 512.

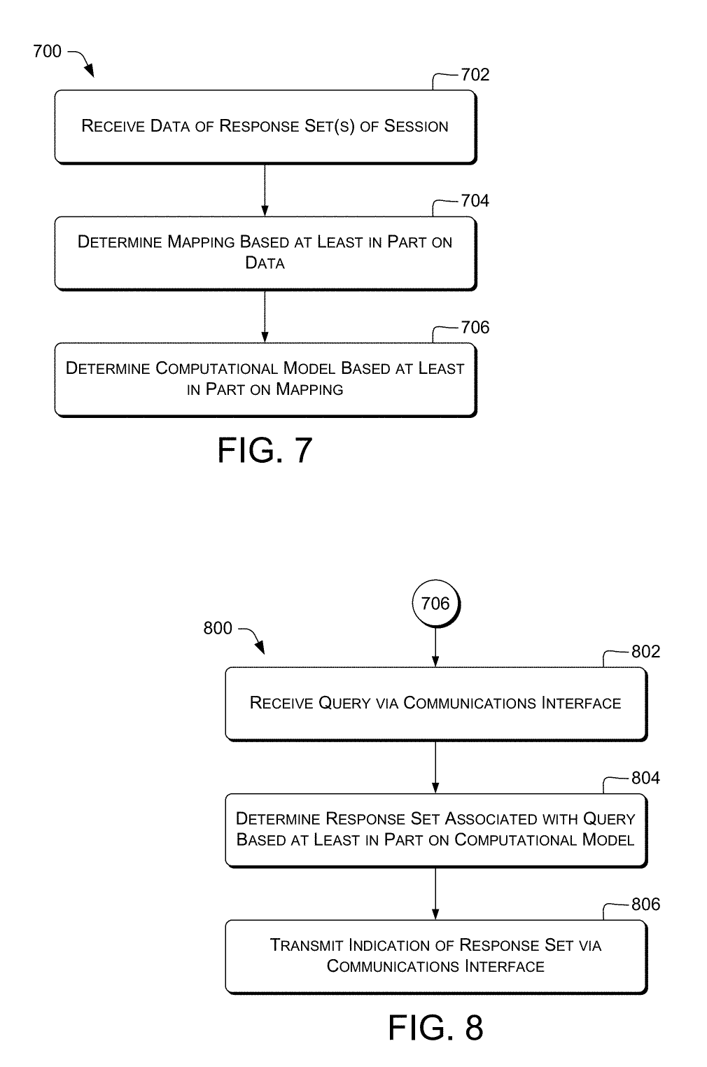

FIG. 7 is a flow diagram that illustrates an example process 700 for determining and operating computational model(s) 126. For example, steps of process 700 can be used to determine a target policy.

In some examples, at block 702, data can be received of at least one response set, e.g., a plurality of response sets, associated with a session. The response sets can be, e.g., response sets Sᵢ of logging data 406. The data for the at least one response set Sᵢ, e.g., for at least one response set and/or for each response set of the plurality of response sets, can indicate a respective plurality of responses Sᵢ[j], a respective response order, and a respective result value rᵢ. The response order can indicate the order of the responses in the response set Sᵢ. Examples are discussed above, e.g., with reference to Eq. (1), logging data 406, reception module 230, and/or FIG. 4.

In some examples, at block 704, based at least in part on the data (e.g., logging data 406), a mapping can be determined. The mapping can take as inputs a response at a position in a response order. The mapping can provide as output a result value based on the inputs. For example, the mapping can include a decomposition such as discussed above. Examples are discussed above, e.g., with reference to the decomposition module 226, Eqs. (1)-(4), and/or FIG. 4.

In some examples, block 704 can further include determining the mapping further providing as output an additional result value based on the inputs of the response at the position in the response order. For example, search results provided by a search engine can be evaluated based on click-through rate, dwell time, and/or other metrics described herein, e.g., with reference to FIG. 10. In some examples, the mapping can provide one metric for each candidate tuple K_{c} (see, e.g., Eq. (7)). In some examples, the mapping can provide two and/or more metrics for each candidate tuple K_{c}. In some examples, the mapping can provide a composite metric for each candidate tuple K_{c}. The composite metric can be a function of multiple metrics, e.g., a linear and/or nonlinear function.

In some examples, at block 706, based at least in part on the mapping, a computational model can be determined. The computational model, e.g., the target policy of FIG. 4 (second CM 412) can provide a scoring value for a candidate response set. The scoring value can be and/or include, e.g., a predicted result value. Examples are discussed above, e.g., with reference to the determination module 228, the action-selection module 236, and/or FIG. 4. In some examples, the scoring value is and/or includes a predicted result \hat{r}(x, S) of a candidate response set S, e.g., as discussed above with reference to Eq. (5).

In some examples, block 706 can include determining the computational model (target policy) based at least in part on multiple metrics and/or a composite metric, as discussed above with reference to block 704. For example, block 706 can include performing multivariate mathematical optimization to determine the target policy so that the result values for multiple metrics are, and/or the result value for a composite metric is, within predetermined ranges and/or meet predetermined acceptance criteria.

FIG. 8 is a flow diagram that illustrates an example process 800 for operating computational model(s) 126. Block 802 can follow block 706.

In some examples, at block 802, a query 414 can be received via the communications interface 214. Examples are discussed above, e.g., with reference to block 506.

In some examples, at block 804, a response set associated with the query can be determined based at least in part on the computational model. Examples are discussed above, e.g., with reference to blocks 508 and/or 510. For example, one or more candidate response sets can be determined, and the computational model can be used to determine respective scoring values for the candidate response sets. The candidate response set having the highest respective scoring value can be selected as the response set. In some examples, the response set can be assembled from high-scoring query-document pairs, e.g., as discussed herein with reference to Eq. (7).

In some examples, the query can be associated with (e.g., provided by and/or making reference to) an entity 110. In some examples, block 804 can include determining the response set associated with the query further based at least in part on stored information associated with the entity 110. For example, as noted above, when selecting responses for a response set, weight can be given to the geographic location of an entity 110 and/or other entity-specific factors.

In some examples, the query can include text, e.g., provided by a user. In some examples, block 804 can include determining the response set associated with the query comprising a plurality of responses, individual responses of the plurality of responses comprising at least one of text and/or hyperlink(s). Examples of such responses can include output( ) and linkto( ) actions noted above. For example, the plurality of responses can include search results.

In some examples, at block 806, an indication of the response set associated with the query can be transmitted via the communications interface 214. Examples are discussed above, e.g., with reference to block 512.

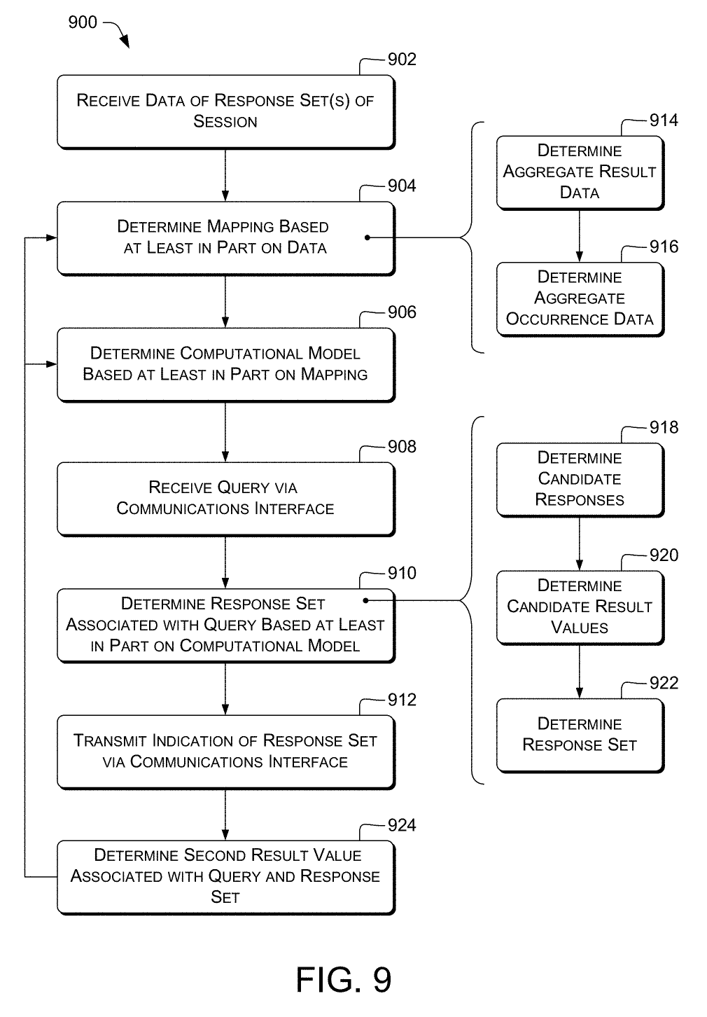

FIG. 9 is a flow diagram that illustrates an example process 900 for determining and/or operating computational model(s) 126. Blocks 902, 904, 906, 908, 910, and 912 can represent blocks 702, 704, 706, 802, 804, and 806, respectively. In some examples, block 904 can include blocks 914 and 916. In some examples, block 910 can include blocks 918-922. In some examples, block 912 can be followed by block 924.

In some examples, at block 914, aggregate result data can be determined based at least in part on at least one of the respective result values, e.g., of the at least one response set and/or plurality of response sets. For example, aggregate result data values \hat{θ}ᵢ can be determined as discussed herein with reference to Eq. (2). The aggregate result data values \hat{θ}ᵢ can represent, e.g., user preferences and/or other result values expressed in the context of a logging policy such as first CM 410, FIG. 4. Since the result value associated with a particular action can vary depending on the modifier value, e.g., slot index j, of that action in an action set such as a response set, the result value of an action under the logging policy may not be equal to the result value of an action under the target policy.

In some examples, at block 916, aggregate occurrence data can be determined based at least in part on the at least one response set. For example, aggregate occurrence data including a matrix F can be determined as discussed herein with reference to Eq. (3). The aggregate occurrence data can represent contributions of various actions in various positions to the result value of an action set, e.g., in the logging data 406, as discussed above. Block 916 can be followed by block 908.

In some examples using blocks 914 and 916, block 906 can include determining the computational model based at least in part on the aggregate result data \hat{θ}ᵢ from block 914 and the aggregate occurrence data Γ from block 916. For example, the computational model can be determined as discussed herein with reference to Eqs. (4)-(6).

In some examples, at block 918, a plurality of candidate responses associated with a query can be determined. For example, as discussed herein with reference to the action-selection module 236, FIG. 4, full-text search and/or other algorithms can be used to determine the candidate responses.

In some examples, at block 920, the computational model can be operated to determine candidate result values for respective combinations of a respective candidate response of the plurality of candidate responses and a respective candidate response order. Examples are discussed above, e.g., with reference to the action-selection module 236 and/or Eq. (7).

In some examples, at block 922, a response set associated with the query can be determined. The response set associated with the query can include candidate responses of the plurality of candidate responses having respective candidate result values exceeding a selected threshold. The selected threshold can include a particular numeric value and/or a result value associated with a rank. For example, the selected threshold can be set equal to the l+1^{th} candidate result value, when the candidate result values are sorted in descending order of candidate result value, to retain the l highest result values as the response set. Examples are discussed above, e.g., with reference to the action-selection module 236, FIG. 4.

In some examples, at block 924, a second result value associated with the query, and with the response set associated with the query, can be determined. For example, the result value can be received via the communications interface 214, e.g., by reception module 230. Various examples of determining the second result value are discussed below with reference to FIG. 10.

In some examples, block 924 can be followed by block 904 and/or 906. This can permit updating the mapping and/or the computational model based on data of the query, the response set, and the second result value. For example, data of the second session can be used in addition to and/or instead of data of the first session in determining the mapping (block 904) and/or the computational model (block 906).

FIG. 10 is a flow diagram that illustrates an example process 1000 for determining a result value, e.g., a second result value such as discussed above with reference to block 924. Block 924 can include performing at least one operation of process 1000. Process 1000 can be implemented by and/or embodied in, e.g., result-determining module 234. Process 1000 can include determining result information, at block 1002, and determining the result value 420, at block 1004. Block 1002 can include at least one of blocks 1006-1020. Block 1004 can include at least one of blocks 1022 and/or 1024. In some examples, block 912 can be followed by block 1006, block 1012, and/or block 1020.

For clarity of explanation, examples of result values are discussed herein with reference to scalar, real- and/or integer-value result values, in which higher (and/or more positive) result values indicate higher user satisfaction and/or a more preferable action than do lower (and/or more negative) result values. However, these examples are not limiting. Other examples of result values are discussed above with reference to FIG. 1. For clarity, control flows are shown solid and data flows (where different from control flows, in some examples) are shown dashed.

In some examples, at block 1006, a response to the provided indication of the response set can be awaited. For example, the action engine 224, e.g., the reception module 230, can wait for a selected timeout period for data to be received the communications interface 214.

At decision block 1008, it can be determined whether the timeout period has elapsed without receiving a response to the indication of the response set. If not, processing can resume in block 1006. If so, processing can continue to block 1010.

In some examples, control program 140 on computing device 104 can provide additional information. For example, a client-side heartbeat script running in a web browser (and/or other control program 140) can provide information about “dwell time,” the amount of time a particular web page is maintained in the user's view and/or in a focused and/or visible state. In some examples, control program 140 can further provide an indication if, e.g., the web browser tab and/or application showing the provided indication, e.g., a results page, is closed and/or terminated. In some examples, block 1008 can include determining whether the timeout period has elapsed based at least in part on dwell-time information, e.g., provided by control program 140 and/or measured by computing device 102. For example, block 1008 can include, in response to control program 140 reporting that the web browser has been closed, determining that the timeout period has elapsed, regardless of the actual amount of wall-clock (real) time that has passed.

In some examples, at block 1010, the result information can be determined indicating that the timeout period has elapsed. For example, the result information can include a Boolean, bit field, flag, and/or other value indicating whether or not the timeout elapsed, and block 1010 can include setting that value to indicate the timeout did elapse. In some examples, block 1010 can include determining the result information including, indicating, and/or otherwise based at least in part on, dwell-time information from control program 140.

In some examples, the result information can be determined based at least in part on respective timestamps of at least two data items received via communications interface 214, e.g., a network interface.

In some examples, at block 1012, a first data item can be received via the communications interface 214. The first data item can be associated with the session. For example, the first data item can include a heartbeat signal, cookie-setting message, pingback, HTTP request, onClick alert, and/or other message indicating user interaction (and/or lack thereof) with the provided indication of the response set, e.g., provided search results. Block 1012 can be followed by block 1014 and/or block 1016.

In some examples, at block 1014, the result information can be determined based at least in part on a timestamp of the received first data item. For example, the result information can be determined to include the timestamp and/or a value derived from the timestamp, such as whether or not the first data item was received during the daytime. In some examples, the result information can be determined based at least in part on and/or indicating a duration between providing of the indication of the response set (block 912) and receiving of the first data item (block 1012).

In some examples, at block 1016, a second data item can be received via the communications interface 214. The second data item can be associated with the session. The second data item can include data of one or more types described above with reference to the first data item, and can include data of same type(s) as the first data item and/or of different type(s).

In some examples, at block 1018, the result information can be determined based on, e.g., indicating, a time between items. Block 1018 can include determining the result information including a duration between a timestamp of receipt of the first data item and a timestamp of receipt of the second data item. The duration can be measured in seconds, ticks, packets received and/or transmitted, and/or other time measures.

In some examples, at block 1020, the result information can be received via the communications interface 214, e.g., a network interface.

In some examples, block 1004 can include determining the result value 420, e.g., based at least in part on result information determined as described above with reference to blocks 1006-1020.

In some examples using block 1020, block 1022 can include determining the result value 420 based at least in part on the received result information. For example, block 1022 can include determining the result value 420 to be a value received via the communications interface 214 and incorporated into the result information.

In some examples, the indication of response set 418 can include and/or be accompanied with data of one or more controls (and/or other user-interface and/or feedback elements, e.g., buttons and/or hypertext links, and likewise throughout this paragraph) configured to solicit user feedback regarding the response set 418 and/or a response therein. For example, the indication can be transmitted as part of a web page including hypertext links for “thumbs-up” and “thumbs-down” buttons. In some examples, block 1020 can include receiving data indicating that such links were clicked, and/or that other controls were operated to indicate a satisfaction of entity 110 with the response set and/or at least one response therein. In some of these examples, block 1022 can include determining the result value based at least in part on the received data indicating operation of such controls by entity 110. For example, block 1022 can include at least one of: determining a positive result value 420 in response to user actuation of a “Like” and/or “thumbs-up” link, and/or determining a negative result value 420 in response to user actuation of a “Dislike” and/or “thumbs-down” link.

In some examples, block 1020 can include receiving data indicating a change in the user's view of results provided in the course of presenting the response set 418 and/or otherwise carrying out at least one action of an action set. In a web-search example, the response set can include a list of links to search results. Block 1020 can include receiving, e.g., from a client-side heartbeat script and/or other component of control program 140 and/or computing device 104, an indication that the user has opened one or more links, e.g., in different browser tabs, and/or that the user has changed from viewing one tab and/or result to viewing another tab and/or result. In some of these examples, block 1022 can include determining the result value based at least in part on the received data indicating such view changes. For example, block 1022 can determine a result value 420 inversely proportional to the number of view changes before a subsequent query and/or a timeout. In this example, if the first result link the user clicks provides the user with desired information, the result value 420 will be relatively higher. However, if the user has to click multiple result links before finding the desired information, as indicated by multiple view changes, the result value 420 will be relatively lower.

In another example in which an action includes presenting search results, block 1022 can include determining, e.g., a positive result value 420 if the user clicks a link on a presented page of search results (response set 418) (as indicated by data received in block 1020). Block 1022 can include determining a less positive, zero, and/or negative result value 420 if the user does not click a link on the page of search results, and/or if the user clicks a “next page” link to receive more results. In this example, if the first page of search results includes a link of interest to the user, the result value 420 is higher than if the first page does not include such a link.

In another example, computing device 102 can transmit a “more results” link and/or other control in association with the indication of the response set. In some of these examples, block 1020 can include receiving an indication of whether the user (entity 110) has clicked the “more results” link. Block 1022 can include determining a relatively lower result value 420 is the user clicks the “more results” link than if the user does not click the “more results” link, e.g., before closing the page and/or tab showing the indication, and/or before a timeout has elapsed. If the user does not click the “more results” link, the content of the response set was likely sufficient, e.g., to answer the user's question. However, if the user does not click the link, the provided information was likely not sufficient to answer the user's question.

In some examples, block 1020 can include receiving information from one or more third parties about user satisfaction with the response set. Block 1022 can include determining the result value 420 based at least in part on the received information. For example, the session can involve interactions between a user and a taxi-reservation service. The action set can include one or more of: presenting links to taxi companies; presenting contact information for taxi companies; presenting reviews for taxi companies and/or drivers; presenting and/or linking to a reservation interface to permit the user to directly schedule a taxi pickup; presenting and/or linking to alternatives to taxi transportation; and/or directly making a reservation with a taxicab company, e.g., a preferred taxicab company indicated in a stored user preference. In some examples, an action set including only actions for, e.g., presenting and/or linking to information can be an example of a response set 418. In an example in which the action set includes presenting a reservation interface for a particular taxicab company and/or making a reservation, the result value 420 can include an amount paid by the customer for a taxi ride with the particular taxicab company. Block 1022 can include determining a result value 420, e.g., proportional to the difference between the amount paid and the average amount paid for that fare, and/or proportional to the difference between the tip percentage paid and a typical percentage, e.g., 10% or 15%. In this way, the result value 420 can indicate how satisfied the user was with the cab ride, measured by the user's willingness to pay.

In some examples using block 1010, block 1014, and/or block 1018, the result value can be determined based at least in part on a timestamp of the first data item, and/or on a time duration determined based at least in part on a timestamp of the first data item.

In some examples, at block 1024, the result value 420 is determined based at least in part on respective timestamps of a plurality of data items, e.g., the first and second data items, received via communications interface 214, e.g., a network interface. In some examples, at block 1024, the result value 420 is determined based at least in part on a timestamp of the first data item. In some examples, at block 1024, the result value 420 is determined based at least in part on a duration between a timestamp of transmission of the indication of the response set (in block 912) and a timestamp of receipt of the first data item and/or of another data item of a plurality of data items.

In some examples using blocks 1010 and 1024, the session can include an interaction between entity 110 operating a computing device 104 and computing device 102 operating an information-retrieval service. For example, the information-retrieval service can respond to the query “who was the first president of the United States” with the answer “George Washington.” Entity 110, e.g., if satisfied with the provided answer, can use that answer in ways that do not involve interaction with computing device 102 (and/or that do not involve interaction with the information-retrieval service). In this situation, block 1010 can include determining that the timeout period has elapsed. In response, block 1024 can include determining that the task was completed successfully, and determine, e.g., a positive result value 420 and/or other indication of task success. Alternatively, entity 110, e.g., if not satisfied with the provided answer, can submit further queries to computing device 102. In this situation, block 1010 can include determining that the timeout period has not elapsed, e.g., further communications have been received before the end of the timeout period. In response, block 1024 can include determining that the task was not completed, and/or was not completed successfully. Block 1024 can include, in response, refraining from determining a result value 420, and/or determining, e.g., a negative result value 420 and/or other indication of task failure and/or absence of task success.

In some examples using at least one of blocks 1012-1018, and block 1024, the first and second data items can include indications that a link was clicked. In an example of a web page containing search results, at least one of the search results can include a redirect URL. Additionally or alternatively, control program 140 can detect click and/or touch events (or other events, e.g., hover) on one or more links and report them, e.g., via an XMLHttpRequest. Blocks 1012 and 1016 can include receiving respective data items, each data item including, e.g., a request for the redirect URL and/or an XMLHttpRequest transfer. Block 1024 can include determining the result value 420, e.g., inversely proportional to the difference between timestamps of the first and second data items. For example, if the first link the user clicked was not useful, and the user relatively quickly moved on to another link, the result value 420 can be lower than if the first link the user clicked was useful, as indicated by a relatively longer amount of time before the user clicked on another link.

FIG. 11 is a flow diagram that illustrates an example process 1100 for determining computational model(s) 126. For example, steps of process 1100 can be used to determine a target policy.

In some examples, at block 1102, aggregate result data can be determined, e.g., as discussed herein with reference to block 914. The aggregate result data can be determined, e.g., based at least in part on data of an action set (e.g., a slate and/or response set), a result value associated with and/or included in the action set, and a first computational model 410, e.g., a logging policy. The first CM 410 can associate the action set Sᵢ with a corresponding state value xᵢ, e.g., as discussed above with reference to FIG. 4. The action set Sᵢ can include a plurality of slots, e.g., numbered 1 . . . l, and respective actions aⱼ. The action set Sᵢ can include and/or be associated with the result value rᵢ.

In some examples, at block 1104, aggregate occurrence data can be determined based at least in part on the data of the action set. Examples are discussed above, e.g., with reference to block 916 and/or Eq. (3). In some examples, e.g., using a stochastic logging policy, the aggregate occurrence data can be determined further based at least in part on the first computational model 410.

In some examples, at block 1106, second aggregate occurrence data can be determined based at least in part on a second computational model 412, e.g., a target policy π. The second aggregate occurrence data P_{π} can be determined as in Eq. (8).

$${P}_{π , {x}_{i}} = {\sum }_{S ∈ test slates} π ( S \vert {x}_{i} ) {Ind}_{s}^{T} \qquad ( 8 )$$

In some examples, the “test slates,” i.e., the set action sets S used in computing Eq. (8), can be sampled from the logging data 406. Additionally or alternatively, one or more test slates can be determined by combining allowed responses, e.g., selected at random, for individual ones of the slots in the action set. Allowed responses are discussed above with reference to FIG. 4.

In some examples, at block 1108, a prediction value associated with the second computational model 412, the target policy, can be determined. The prediction value can be determined based at least in part on the aggregate result data, the aggregate occurrence data, and the second aggregate occurrence data. An example is shown in Eq. (9).

$${\hat{V}}_{PI} = \frac{1}{n} {\sum }_{i = 1}^{n} {P}_{π , {x}_{i}}^{T} {Γ}_{μ , {x}_{i }}^{†} {\hat{θ}}_{i} \qquad ( 9 )$$

where n is the number of records of logging data 406 over which the prediction value \hat{V}_{PI} is computed. Records of logging data 406 can be selected at random or in a predetermined order, and all or fewer than all available records can be used in computing Eq. (9). In some examples, including the example of Eq. (9), the prediction value can be determined based at least in part on a pseudoinverse Γ^{†} of the aggregate occurrence data Γ. In other examples, as discussed above, the prediction value can be determined by solving a system of linear Eqs., e.g., other than by pseudoinverse computation.

FIG. 12 is a flow diagram that illustrates an example process 1200 for determining and operating computational model(s) 126. Block 1202 can follow block 1106 and/or 1108.

In some examples, at block 1202, third aggregate occurrence data can be determined based at least in part on a third computational model. Examples are discussed above, e.g., with reference to blocks 916, 1104, and/or 1106. The third computational model can represent, e.g., an alternative candidate policy. In some examples, the second CM 412 and the third CM are candidate policies. In some examples, block 1202 can include block 1204.

In some examples, at block 1204, the third computational model can be operated a plurality of times to provide respective samples. The third aggregate occurrence data can then be determined based further on at least some of the respective samples. This can permit determining expected and/or typical behavior of the third computational model without requiring exhaustive testing.

Similarly, in some examples, block 1106, FIG. 11, can include operating the second computational model a plurality of times to provide respective second-model samples. Block 1106 can further include determining the second aggregate occurrence data (associated with the second computational model) based further on at least some of the respective second-model samples.

In some examples, at block 1206, a second prediction value can be determined. The second prediction value can be associated with the third computational model, and can be determined based at least in part on the aggregate result data, the aggregate occurrence data, and the third aggregate occurrence data. Examples are discussed above, e.g., with reference to block 1108. Blocks 1202 and 1206 can be repeated for any number of candidate computational models.

In some examples, at block 1208, the second computational model or the third computational model can be selected based at least in part on the prediction value and the second prediction value to provide a policy, e.g., a target policy. In some examples, exactly one CM can be selected, and/or a predetermined number of CMs can be selected. For example, the second CM can be selected if the prediction value exceeds the second prediction value, and the third CM can be selected otherwise. In some examples, block 1208 can include selecting one computational model from a plurality of candidate policies, e.g., more than two candidate policies.

In some examples, at block 1210, a second action set can be determined based at least in part on the policy and a query. Examples are discussed above, e.g., with reference to blocks 510, 804, and/or 910. This can permit the second action set to be determined using, as a policy, a computational model determined to be more effective than at least one other computational model.

### Example Clauses

A: A system comprising: a communications interface; at least one processing unit adapted to execute modules; and one or more computer-readable media having thereon a plurality of the modules, the plurality of the modules comprising: a module of an evaluation engine that is configured to: determine a decomposition of data of actions of a first session based at least in part on a first computational model associating the actions of the first session with corresponding state values of the first session; a module of a modeling engine that is configured to: determine a second computational model based at least in part on the decomposition and an operation template; a module of an action engine that is configured to: receive a query via the communications interface, the query associated with the second session; determine a state value of the second session based at least in part on the query; operate the second computational model to determine at least one response associated with the query based at least in part on the state value of the second session; and provide an indication of the at least one response via the communications interface.

B: A system as recited in paragraph A, wherein the decomposition comprises a plurality of relevance functions and at least one relevance function of the plurality of relevance functions is associated with a modifier value and is configured to determine a predicted result value for a particular action in association with a particular state value and the modifier value.

C: A system as recited in paragraph B, wherein the actions of the first session are associated with respective positions in at least one action set and the modifier value comprises a position.

D: A system as recited in any of paragraphs A-C, wherein the at least one response comprises a plurality of responses associated with respective positions in a response set and the action engine is further configured to determine the respective positions based at least in part on scoring values provided by the second computational model for respective responses of the plurality of responses and the state value of the second session.

E: A system as recited in any of paragraphs A-D, wherein the action engine is further configured to: receive a second query via the communications interface, the second query associated with the second session; determine a second state value of the second session based at least in part on the second query; operate the second computational model to determine at least one second response associated with the second query based at least in part on the second state value of the second session; and provide an indication of the at least one second response via the communications interface.

F: A system as recited in any of paragraphs A-E, wherein individual responses of the at least one response comprise at least text and/or hyperlink(s) and the communications interface comprises a network interface.

G: A system as recited in any of paragraphs A-F, wherein a first response of the at least one response matches a second response of the at least one response.

H: An apparatus, comprising: at least one processor; and a computer-readable medium including instructions to, when executed by the at least one processor, cause the at least one processor to: receive data of at least one response set associated with a session, the data for the at least one response set indicating a respective plurality of responses, a respective response order, and a respective result value; determine, based at least in part on the data, a mapping providing as output a result value based on inputs of a response at a position in a response order; and determine, based at least in part on the mapping, a computational model providing a scoring value for a candidate response set.

I: An apparatus as recited in paragraph H, further comprising a communications interface, the instructions further to cause the at least one processor to: receive a query via the communications interface; determine a response set associated with the query based at least in part on the computational model; and transmit an indication of the response set associated with the query via the communications interface.

J: An apparatus as recited in paragraph I, the instructions further to cause the at least one processor to determine a second result value associated with the query, and with the response set associated with the query.

K: An apparatus as recited in paragraph J, the instructions further to cause the at least one processor to determine the second result value based at least in part on respective timestamps of a plurality of data items received via the communications interface.

L: An apparatus as recited in paragraph J or K, the instructions further to cause the at least one processor to receive result information via the communications interface and determine the second result value based at least in part on the received result information.

M: An apparatus as recited in any of paragraphs I-L, the query associated with an entity and the instructions further to cause the at least one processor to determine the response set associated with the query further based at least in part on stored information associated with the entity.

N: An apparatus as recited in any of paragraphs I-M, the query comprising text and the instructions further to cause the at least one processor to determine the response set associated with the query comprising a plurality of responses, individual responses of the plurality of responses comprising at least one of text and/or hyperlink(s).

O: An apparatus as recited in any of paragraphs H-N, the instructions further to cause the at least one processor to: determine a plurality of candidate responses associated with a query; operate the computational model to determine candidate result values for respective combinations of a respective candidate response of the plurality of candidate responses and a respective candidate response order; and determine a response set associated with the query including candidate responses of the plurality of candidate responses having respective candidate result values exceeding a selected threshold.

P: An apparatus as recited in any of paragraphs H-O, the instructions further to cause the at least one processor to: determine the mapping further providing as output an additional result value based on the inputs of the response at the position in the response order.

Q: An apparatus as recited in paragraph P, the instructions further to cause the at least one processor to determine the mapping further providing as output a composite metric based at least in part on the result value and the additional result value.

R: An apparatus as recited in any of paragraphs H-Q, the instructions further to cause the at least one processor to: determine aggregate result data based at least in part on at least one of the respective result values; determine aggregate occurrence data based at least in part on the at least one response set; and determine the computational model based at least in part on the aggregate result data and the aggregate occurrence data.

S: A method, comprising: determining aggregate result data based at least in part on data of an action set, an associated result value, and a first computational model that associates the action set with a corresponding state value, wherein the action set includes a plurality of slots and respective actions; determining aggregate occurrence data based at least in part on the data of the action set; determining second aggregate occurrence data based at least in part on a second computational model; and determining a prediction value associated with the second computational model based at least in part on the aggregate result data, the aggregate occurrence data, and the second aggregate occurrence data.

T: A method as recited in paragraph S, further comprising determining the aggregate occurrence data further based at least in part on the first computational model.

U: A method as recited in paragraph S or T, further comprising: determining third aggregate occurrence data based at least in part on a third computational model; determining a second prediction value associated with the third computational model based at least in part on the aggregate result data, the aggregate occurrence data, and the third aggregate occurrence data; selecting the second computational model or the third computational model based at least in part on the prediction value and the second prediction value to provide a policy; and determining a second action set based at least in part on the policy and a query.

V: A method as recited in any of paragraphs S-U, further comprising determining the prediction value based at least in part on a pseudoinverse of the aggregate occurrence data.

W: A method as recited in any of paragraphs S-V, further comprising operating the second computational model a plurality of times to provide respective samples and determining the second aggregate occurrence data based further on at least some of the respective samples.

X: A computer-readable medium, e.g., a computer storage medium, having thereon computer-executable instructions, the computer-executable instructions upon execution configuring a computer to perform operations of any of the modules as any of paragraphs A-G recites.

Y: A computer-readable medium, e.g., a computer storage medium, having thereon computer-executable instructions, the computer-executable instructions upon execution configuring a computer to perform operations of any of the modules as any of paragraphs H-R recites.

Z: A computer-readable medium, e.g., a computer storage medium, having thereon computer-executable instructions, the computer-executable instructions upon execution configuring a computer to perform operations as any of paragraphs S-W recites.

AA: A device comprising: a processor; and a computer-readable medium, e.g., a computer storage medium, having thereon computer-executable instructions, the computer-executable instructions upon execution by the processor configuring the device to perform operations as any of paragraphs S-W recites.

AB: A system comprising: means for processing; and means for storing having thereon computer-executable instructions, the computer-executable instructions including means to configure the system to carry out a method as any of paragraphs S-W recites.

AC: A system, comprising: means for determining aggregate result data based at least in part on data of an action set, an associated result value, and a first computational model that associates the action set with a corresponding state value, wherein the action set includes a plurality of slots and respective actions; means for determining aggregate occurrence data based at least in part on the data of the action set; means for determining second aggregate occurrence data based at least in part on a second computational model; and means for determining a prediction value associated with the second computational model based at least in part on the aggregate result data, the aggregate occurrence data, and the second aggregate occurrence data.

AD: A system as recited in paragraph AC, further comprising means for determining the aggregate occurrence data further based at least in part on the first computational model.

AE: A system as recited in paragraph AC or AD, further comprising: means for determining third aggregate occurrence data based at least in part on a third computational model; means for determining a second prediction value associated with the third computational model based at least in part on the aggregate result data, the aggregate occurrence data, and the third aggregate occurrence data; means for selecting the second computational model or the third computational model based at least in part on the prediction value and the second prediction value to provide a policy; and means for determining a second action set based at least in part on the policy and a query.

AF: A system as recited in any of paragraphs AC-AE, further comprising means for determining the prediction value based at least in part on a pseudoinverse of the aggregate occurrence data.

AG: A system as recited in any of paragraphs AC-AF, further comprising means for operating the second computational model a plurality of times to provide respective samples and means for determining the second aggregate occurrence data based further on at least some of the respective samples.

AH: A system comprising: a communications interface; at least one processing unit adapted to execute modules; and one or more computer-readable media having thereon a plurality of the modules, the plurality of the modules comprising: a module of an evaluation engine that is configured to: determine a decomposition of data of actions of a first session based at least in part on a first computational model associating the actions of the first session with corresponding state values of the first session; a module of a modeling engine that is configured to: determine a second computational model based at least in part on the decomposition and an operation template; a module of an action engine that is configured to: receive a query via the communications interface, the query associated with the second session; determine a state value of the second session based at least in part on the query; operate the second computational model to determine at least one action associated with the query based at least in part on the state value of the second session; and perform the at least one action associated with the query.

AI: A system as recited in paragraph AH, wherein the performing the at least one action comprises at least one of transmitting data or receiving data via the communications interface.

AJ: A system as recited in paragraph AH or AI, wherein the decomposition comprises a plurality of relevance functions and at least one relevance function of the plurality of relevance functions is associated with a modifier value and is configured to determine a predicted result value for a particular action in association with a particular state value and the modifier value.

AK: A system as recited in paragraph AJ, wherein the actions of the first session are associated with respective positions in at least one response set and the modifier value comprises a position.

AL: A system as recited in any of paragraphs AH-AK, wherein the at least one action comprises a plurality of actions of the second session, actions of the plurality of actions of the second session associated with respective positions in an action set, and the action engine is further configured to determine the respective positions based at least in part on scoring values provided by the second computational model for respective actions of the plurality of actions of the second session and the state value of the second session.

AM: A system as recited in any of paragraphs AH-AL, wherein the action engine is further configured to: receive a second query via the communications interface, the second query associated with the second session; determine a second state value of the second session based at least in part on the second query; operate the second computational model to determine at least one second action associated with the second query based at least in part on the second state value of the second session; and perform the at least one second action associated with the second query.

AN: A system as recited in paragraph AM, wherein the performing the at least one second action associated with the second query comprises at least one of transmitting data or receiving data via the communications interface.

AO: A system as recited in any of paragraphs AH-AN, wherein individual responses of the at least one response comprise at least text and/or hyperlink(s) and the communications interface comprises a network interface.

AP: A computer-readable medium, e.g., a computer storage medium, having thereon computer-executable instructions, the computer-executable instructions upon execution configuring a computer to perform operations of any of the modules as any of paragraphs AH-AO recites.

### CONCLUSION

Various computational-model determination and operation techniques described herein can permit more efficiently analyzing data, e.g., of a session such as a communication session with an entity, and more readily determining actions to be taken in that session, e.g., to assist the entity in achieving a goal. Various examples can provide more effective ongoing determination of computational models, e.g., based on interactions over the course of the session, providing improved accuracy compared to prior schemes. Various examples can permit testing and/or improving accuracy and/or effectiveness of CMs using a smaller dataset than some previous schemes do. Various examples can reduce the elapsed-time, power, storage, processing, or data-collection requirements of CM determination while maintaining and/or improving accuracy. Various examples can permit testing and/or improving accuracy and/or effectiveness of CMs without requiring those CMs to be operated at run time, e.g., during an A/B test.

Although the techniques have been described in language specific to structural features and/or methodological acts, it is to be understood that the appended claims are not necessarily limited to the features and/or acts described. Rather, the features and acts are described as example implementations of such techniques. For example, network 108, processing unit(s) 114, and other structures described herein for which multiple types of implementing devices and/or structures are listed can include any of the listed types, and/or multiples and/or combinations thereof.

The operations of the example processes are illustrated in individual blocks and summarized with reference to those blocks. The processes are illustrated as logical flows of blocks, each block of which can represent one or more operations that can be implemented in hardware, firmware, software, and/or a combination thereof. In the context of software, for example, the operations represent computer-executable instructions stored on one or more computer-readable media that, when executed by one or more processors, enable the one or more processors to perform the recited operations. Generally, computer-executable instructions include routines, programs, objects, modules, components, data structures, and the like that perform particular functions and/or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more computing device(s) 102, 104, and/or 200 such as one or more internal and/or external CPUs and/or GPUs, and/or one or more pieces of hardware logic such as FPGAs, DSPs, and/or other types described above.

All of the methods and processes described above can be embodied in, and fully automated via, software code modules executed by one or more computers and/or processors. The code modules can be embodied in any type of computer-readable medium. Some and/or all of the methods can be embodied in specialized computer hardware.

Conditional language such as, among others, “can,” “could,” “might” and/or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples and/or that one or more examples necessarily include logic for deciding, with and/or without user input and/or prompting, whether certain features, elements and/or steps are included and/or are to be performed in any particular example. The word “or” and the phrase “and/or” are used herein in an inclusive sense unless specifically stated otherwise. Accordingly, conjunctive language such as, but not limited to, at least the phrases “X, Y, or Z,” “at least X, Y, or Z,” “at least one of X, Y or Z,” and/or any of those phrases with “and/or” substituted for “or,” unless specifically stated otherwise, is to be understood as signifying that an item, term, etc., can be either X, Y, or Z, or a combination of any elements thereof (e.g., a combination of XY, XZ, YZ, and/or XYZ).

Any routine descriptions, elements and/or blocks in the flow diagrams described herein and/or depicted in the attached figures should be understood as potentially representing modules, segments, and/or portions of code that include one or more executable instructions for implementing specific logical functions and/or elements in the routine. Alternative implementations are included within the scope of the examples described herein in which elements and/or functions can be deleted and/or executed out of order from any order shown or discussed, including substantially synchronously and/or in reverse order, depending on the functionality involved as would be understood by those skilled in the art. Examples herein are nonlimiting unless expressly stated otherwise, regardless of whether or not any particular example is expressly described as being nonlimiting. It should be emphasized that many variations and modifications can be made to the above-described examples, the elements of which are to be understood as being among other acceptable examples. All such modifications and variations are intended to be included herein within the scope of this disclosure and protected by the following claims. Moreover, in the claims, any reference to a group of items provided by a preceding claim clause is a reference to at least some of the items in the group of items, unless specifically stated otherwise.

What is claimed is:

1. A system comprising:
a communications interface;
at least one processing unit adapted to execute modules; and
one or more computer-readable media having thereon a plurality of the modules, the plurality of the modules comprising:
a module of an evaluation engine that is configured to:
determine a decomposition of data of actions of a first session based at least in part on a first computational model associating the actions of the first session with corresponding state values of the first session;
a module of a modeling engine that is configured to:
determine a second computational model based at least in part on the decomposition and an operation template;
a module of an action engine that is configured to:
receive a query via the communications interface, the query associated with the second session;
determine a state value of the second session based at least in part on the query;
operate the second computational model to determine at least one response associated with the query based at least in part on the state value of the second session; and
provide an indication of the at least one response via the communications interface.

2. A system as recited in claim 1, wherein the decomposition comprises a plurality of relevance functions and at least one relevance function of the plurality of relevance functions is associated with a modifier value and is configured to determine a predicted result value for a particular action in association with a particular state value and the modifier value.

3. A system as recited in claim 2, wherein the actions of the first session are associated with respective positions in at least one action set and the modifier value comprises a position.

4. A system as recited in claim 1, wherein the at least one response comprises a plurality of responses associated with respective positions in a response set and the action engine is further configured to determine the respective positions based at least in part on scoring values provided by the second computational model for respective responses of the plurality of responses and the state value of the second session.

5. A system as recited in claim 1, wherein the action engine is further configured to:
receive a second query via the communications interface, the second query associated with the second session;
determine a second state value of the second session based at least in part on the second query;
operate the second computational model to determine at least one second response associated with the second query based at least in part on the second state value of the second session; and
provide an indication of the at least one second response via the communications interface.

6. A system as recited in claim 1, wherein individual responses of the at least one response comprise at least text and/or hyperlink(s) and the communications interface comprises a network interface.

7. A system as recited in claim 1, wherein a first response of the at least one response matches a second response of the at least one response.

8. An apparatus, comprising:
at least one processor; and
a computer-readable medium including instructions to, when executed by the at least one processor, cause the at least one processor to:
receive data of at least one response set associated with a session, the data for the at least one response set indicating a respective plurality of responses, a respective response order, and a respective result value;
determine, based at least in part on the data, a mapping providing as output a result value based on inputs of a response at a position in a response order; and
determine, based at least in part on the mapping, a computational model providing a scoring value for a candidate response set.

9. An apparatus as recited in claim 8, further comprising a communications interface, the instructions further to cause the at least one processor to:
receive a query via the communications interface;
determine a response set associated with the query based at least in part on the computational model; and
transmit an indication of the response set associated with the query via the communications interface.

10. An apparatus as recited in claim 9, the instructions further to cause the at least one processor to determine a second result value associated with the query, and with the response set associated with the query.

11. An apparatus as recited in claim 10, the instructions further to cause the at least one processor to receive result information via the communications interface and determine the second result value based at least in part on the received result information.

12. An apparatus as recited in claim 9, the query associated with an entity and the instructions further to cause the at least one processor to determine the response set associated with the query further based at least in part on stored information associated with the entity.

13. An apparatus as recited in claim 9, the query comprising text and the instructions further to cause the at least one processor to determine the response set associated with the query comprising a plurality of responses, individual responses of the plurality of responses comprising at least one of text and/or hyperlink(s).

14. An apparatus as recited in claim 8, the instructions further to cause the at least one processor to:
determine a plurality of candidate responses associated with a query;
operate the computational model to determine candidate result values for respective combinations of a respective candidate response of the plurality of candidate responses and a respective candidate response order; and
determine a response set associated with the query including candidate responses of the plurality of candidate responses having respective candidate result values exceeding a selected threshold.

15. An apparatus as recited in claim 8, the instructions further to cause the at least one processor to:
determine the mapping further providing as output an additional result value based on the inputs of the response at the position in the response order.

16. An apparatus as recited in claim 8, the instructions further to cause the at least one processor to:
determine aggregate result data based at least in part on at least one of the respective result values;
determine aggregate occurrence data based at least in part on the at least one response set; and
determine the computational model based at least in part on the aggregate result data and the aggregate occurrence data.

17. A method, comprising:
determining aggregate result data based at least in part on data of an action set, an associated result value, and a first computational model that associates the action set with a corresponding state value, wherein the action set includes a plurality of slots and respective actions;
determining aggregate occurrence data based at least in part on the data of the action set;
determining second aggregate occurrence data based at least in part on a second computational model; and
determining a prediction value associated with the second computational model based at least in part on the aggregate result data, the aggregate occurrence data, and the second aggregate occurrence data.

18. A method as recited in claim 17, further comprising:
determining third aggregate occurrence data based at least in part on a third computational model;
determining a second prediction value associated with the third computational model based at least in part on the aggregate result data, the aggregate occurrence data, and the third aggregate occurrence data;
selecting the second computational model or the third computational model based at least in part on the prediction value and the second prediction value to provide a policy; and
determining a second action set based at least in part on the policy and a query.

19. A method as recited in claim 17, further comprising determining the prediction value based at least in part on a pseudoinverse of the aggregate occurrence data.

20. A method as recited in claim 17, further comprising operating the second computational model a plurality of times to provide respective samples and determining the second aggregate occurrence data based further on at least some of the respective samples.
